(19) United States
(12) Patent Application Publication
(10) Pub. No.: US 2011/0222787 A1
(43) Pub. Date: Sep. 15, 2011

(54) FRAME SEQUENCE COMPARISON IN MULTIMEDIA STREAMS

(76) Inventors: Stefan Thiemert, Darmstadt (DE); Rene Cavet, Darmstadt (DE)

(21) Appl. No.: 12/935,148

(22) PCT Filed: Feb. 28, 2009
(86) PCT No.: PCT/IB09/05407

§ 371 Date: May 26, 2011

Related U.S. Application Data
(60) Provisional application No. 61/032,306, filed on Feb. 28, 2008.

(51) Int. Cl. G06K 9/62

(52) U.S. Cl. 382/225; 382/224

(57) ABSTRACT

In some embodiments, the technology compares multimedia content to other multimedia content via a content analysis server. In other embodiments, the technology includes a system and/or a method of comparing video sequences. The comparison includes receiving a first list of descriptors pertaining to a plurality of first video frames and a second list of descriptors pertaining to a plurality of second video frames; designating first segments of the plurality of first video frames that are similar and second segments of the plurality of second video frames that are similar; comparing the first segments and the second segments; and analyzing the pairs of first and second segments to compare the first and second segments to a threshold value.

### CROSS-REFERENCE TO RELATED APPLICATIONS

This application claims the benefit of U.S. Provisional Application No. 61/032,306 filed Feb. 28, 2008. The entire teachings of the above application are incorporated herein by reference.

### FIELD OF THE INVENTION

The present invention relates to frame sequence comparison in multimedia streams. Specifically, the present invention relates to a video comparison system for video content.

### BACKGROUND

The availability of broadband communication channels to end-user devices has enabled ubiquitous media coverage with image, audio, and video content. The increasing amount of multimedia content that is transmitted globally has boosted the need for intelligent content management. Providers must organize their content and be able to analyze their content. Similarly, broadcasters and market researchers want to know when and where specific footage has been broadcast. Content monitoring, market trend analysis, and copyright protection is challenging, if not impossible, due to the increasing amount of multimedia content. However, a need exists to improve the analysis of video content in this technology field.

### SUMMARY

One approach to comparing video sequences is a process for comparing multimedia segments, such as segments of video. In one embodiment, the video comparison process includes receiving a first list of descriptors pertaining to a plurality of first video frames. Each of the descriptors represents visual information of a corresponding video frame of the sequence of first video frames. The method further includes receiving a second list of descriptors pertaining to a sequence of second video frames. Each of the descriptors relates to visual information of a corresponding video frame of the sequence of second video frames. The method further includes designating first segments of the sequence of first video frames that are similar. Each first segment includes neighboring first video frames. The method further includes designating second segments of the sequence of second video frames that are similar. Each second segment includes neighboring second video frames. The method further includes comparing the first segments and the second segments and analyzing the pairs of first and second segments based on the comparison of the first segments and the second segments to compare the first and second segments to a threshold value.

Another approach to comparing video sequences is a computer program product. In one embodiment, the computer program product is tangibly embodied in an information carrier. The computer program product includes instructions being operable to cause a data processing apparatus to receive a first list of descriptors relating to a sequence of first video frames whereby each of the descriptors represents visual information of a corresponding video frame of the sequence of first video frames. The computer program product further includes instructions being operable to cause a data processing apparatus to receive a second list of descriptors relating to a sequence of second video frames where by each of the descriptors represents visual information of a corresponding video frame of the sequence of second video frames. The computer program product further includes instructions being operable to cause a data processing apparatus to designate one or more first segments of the sequence of first video frames that are similar whereby each first segment includes neighboring first video frames. The computer program product further includes instructions being operable to cause a data processing apparatus to designate one or more second segments of the sequence of second video frames that are similar whereby each second segment includes neighboring second video frames. The computer program product further includes instructions being operable to cause a data processing apparatus to compare at least one of the one or more first segments and at least one of the one or more second segments; and analyze the pairs of first and second segments based on the comparison of the first segments and the second segments to compare the first and second segments to a threshold value.

Another approach to comparing video sequences is a system. In one embodiment, the system includes a communication module, a video segmentation module, and a video segment comparison module. The communication module receives a first list of descriptors pertaining to a sequence of first video frames, each of the descriptors relating to visual information of a corresponding video frame of the sequence of first video frames; and receives a second list of descriptors pertaining to a sequence of second video frames, each of the descriptors relating to visual information of a corresponding video frame of the sequence of second video frames. The video segmentation module designates one or more first segments of the sequence of first video frames that are similar, each of the one or more first segments including neighboring first video frames; and designates one or more second segments of the sequence of second video frames that are similar, each of the one or more second segments including neighboring second video frames. The video segment comparison module compares at least one of the one or more first segments and at least one of the one or more second segments; and analyzes pairs of the at least one first and the at least one second segments based on the comparison of the at least one first segments and the at least one second segments to compare the first and second segments to a threshold value.

Another approach to comparing video sequences is a video comparison system. The system includes means for receiving a first list of descriptors pertaining to a sequence of first video frames, each of the descriptors relating to visual information of a corresponding video frame of the sequence of first video frames. The system further includes means for receiving a second list of descriptors pertaining to a sequence of second video frames, each of the descriptors relating to visual information of a corresponding video frame of the sequence of second video frames. The system further includes means for designating one or more first segments of the sequence of first video frames that are similar, each of the one or more first segments including neighboring first video frames. The system further includes means for designating one or more second segments of the sequence of second video frames that are similar, each of the one or more second segments includes neighboring second video frames. The system further includes means for comparing at least one of the first segments and at least one of the one or more second segments. The system further includes means for analyzing the pairs of first and second segments based on the comparison of the first segments and the second segments to compare the first and second segments to a threshold value.

In other examples, any of the approaches above can include one or more of the following features. In some examples, the analyzing includes determining similar first and second segments.

In other examples, the analyzing includes determining dissimilar first and second segments.

In some examples, the comparing includes comparing each of the one or more first segments to each of the one or more second segments.

In other examples, the comparing includes comparing each of the one or more first segment to each of the one or more second segment that is located within an adaptive window.

In some examples, the method further includes varying a size of the adaptive window during the comparing.

In other examples, the comparing includes designating first clusters of the one or more first segments formed of a sequence of first segments. The comparing can further include for each first cluster, selecting a first segment of the sequence of first segments of that cluster to be a first cluster centroid. The comparing can further include comparing each of the first cluster centroids to each of the second segments. The comparing can further include for each of the second segments within a threshold value of each of the first cluster centroids, comparing the second segments and the first segments of the first cluster.

In some examples, the comparing includes designating first clusters of first segments formed of a sequence of first segments. The comparing can further include for each first cluster, selecting a first segment of the sequence of first segments of that cluster to be a first cluster centroid. The comparing can further include designating second clusters of second segments formed of a sequence of second segments. The comparing can further include for each second cluster, selecting a second segment of the sequence of second segments of that cluster to be a second cluster centroid. The comparing can further include comparing each of the first cluster centroids to each of the second cluster centroids. The comparing can further include for each of the first cluster centroids within a threshold value of each of the second cluster centroids, comparing the first segments of the first cluster and the second segments of the second cluster to each other.

In other examples, the method further includes generating the threshold value based on the descriptors relating to visual information of a first video frame of the sequence of first video frames, and/or the descriptors relating to visual information of a second video frame of the sequence of second video frames.

In some examples, the analyzing is performed using at least one matrix and searching for diagonals of entries in the at least one matrix representing levels of differences in segments of similar video frames

In other examples, the method further includes finding similar frame sequences for previously unmatched frame sequences.

The frame sequence comparison in video streams described herein can provide one or more of the following advantages. An advantage of the frame sequence comparison is that the comparison of multimedia streams is more efficient since a user does not have to view the multimedia streams in parallel, but can more efficiently review the report of an automated comparison to determine the differences and/or similarities between the multimedia streams. Another advantage is that the identification of similar frame sequences provides a more accurate comparison of multimedia streams since an exact bit-by-bit comparison of the multimedia streams is challenging and inefficient.

Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 illustrates a functional block diagram of an exemplary system;

FIG. 2 illustrates a functional block diagram of an exemplary content analysis server;

FIG. 3 illustrates an exemplary block diagram of an exemplary multi-channel video comparing process;

FIG. 4 illustrates an exemplary flow diagram of a generation of a digital video fingerprint;

FIG. 5 illustrates an exemplary result of a comparison of two video streams;

FIG. 6 illustrates an exemplary flow chart of a generation of a fingerprint for an image;

FIG. 7 illustrates an exemplary block process diagram of a grouping of frames;

FIG. 8 illustrates an exemplary block diagram of a brute-force comparison process;

FIG. 9 illustrates an exemplary block diagram of an adaptive window comparison process;

FIG. 10 illustrates an exemplary block diagram of a clustering comparison process;

FIG. 11 illustrates an exemplary block diagram of an identification of similar frame sequences;

FIG. 12 illustrates an exemplary block diagram of similar frame sequences;

FIG. 13 illustrates an exemplary block diagram of a brute force identification process;

FIG. 14 illustrates an exemplary block diagram of an adaptive window identification process;

FIG. 15 illustrates an exemplary block diagram of a extension identification process;

FIG. 16 illustrates an exemplary block diagram of a hole matching identification process;

FIG. 17 illustrates a functional block diagram of an exemplary system;

FIG. 18 illustrates an exemplary report;

FIG. 19 illustrates an exemplary flow chart for comparing fingerprints between frame sequences;

FIG. 20 illustrates an exemplary flow chart for comparing video sequences;

FIG. 21 illustrates a block diagram of an exemplary multi-channel video monitoring system;

FIG. 22 illustrates a screen shot of an exemplary graphical user interface;

FIG. 23 illustrates an example of a change in a digital image representation subframe;

FIG. 24 illustrates an exemplary flow chart for the digital video image detection system; and

FIGS. 25A-25B illustrate an exemplary traversed set of K-NN nested, disjoint feature subspaces in feature space.

### DETAILED DESCRIPTION

By way of general overview, the technology compares multimedia content (e.g., digital footage such as films, clips, and advertisements, digital media broadcasts, etc.) to other multimedia content via a content analyzer. The multimedia content can be obtained from virtually any source able to store, record, or play multimedia (e.g., live television source, network server source, a digital video disc source, etc.). The content analyzer enables automatic and efficient comparison of digital content. The content analyzer can be a content analysis processor or server, is highly scalable and can use computer vision and signal processing technology for analyzing footage in the video and in the audio domain in real time.

Moreover, the content analysis server's automatic content comparison technology is highly accurate. While human observers may err due to fatigue, or miss small details in the footage that are difficult to identify, the content analysis server is routinely capable of comparing content with an accuracy of over 99%. The comparison does not require prior inspection or manipulation of the footage to be monitored. The content analysis server extracts the relevant information from the multimedia stream data itself and can therefore efficiently compare a nearly unlimited amount of multimedia content without manual interaction.

The content analysis server generates descriptors, such as digital signatures—also referred to herein fingerprints—from each sample of multimedia content. The digital signatures describe specific video, audio and/or audiovisual aspects of the content, such as color distribution, shapes, and patterns in the video parts and the frequency spectrum in the audio stream. Each sample of multimedia has a unique fingerprint that is basically a compact digital representation of its unique video, audio, and/or audiovisual characteristics.

The content analysis server utilizes such fingerprints to find similar and/or different frame sequences or clips in multimedia sample. The system and process of finding similar and different frame sequences in multimedia samples can also be referred to as the motion picture copy comparison system (MoPiCCS).

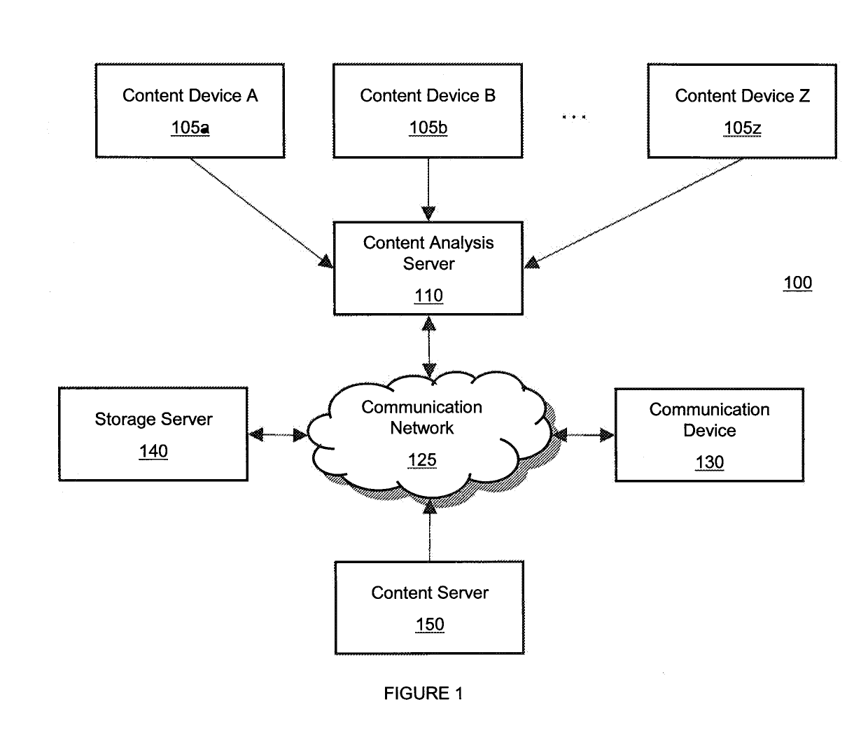

FIG. 1 illustrates a functional block diagram of an exemplary system 100. The system 100 includes one or more content devices A 105a, B 105 through Z 105z (hereinafter referred to as content devices 105), a content analyzer, such as a content analysis server 110, a communications network 125, a communication device 130, a storage server 140, and a content server 150. The devices and/or servers communicate with each other via the communication network 125 and/or via connections between the devices and/or servers (e.g., direct connection, indirect connection, etc.).

The content analysis server 110 requests and/or receives multimedia streams from one or more of the content devices 105 (e.g., digital video disc device, signal acquisition device, satellite reception device, cable reception box, etc.), the storage server 140 (e.g., storage area network server, network attached storage server, etc.), the content server 150 (e.g., internet based multimedia server, streaming multimedia server, etc.), and/or any other server or device that can store a multimedia stream (e.g., cell phone, camera, etc.). The content analysis server 110 identifies one or more frame sequences for each multimedia stream. The content analysis server 110 generates a respective fingerprint for each of the one or more frame sequences for each multimedia stream. The content analysis server 110 compares the fingerprints of one or more frame sequences between each multimedia stream. The content analysis server 110 generates a report (e.g., written report, graphical report, text message report, alarm, graphical message, etc.) of the similar and/or different frame sequences between the multimedia streams.

In other examples, the content analysis server 110 generates a fingerprint for each frame in each multimedia stream. The content analysis server 110 can generate the fingerprint for each frame sequence (e.g., group of frames, direct sequence of frames, indirect sequence of frames, etc.) for each multimedia stream based on the fingerprint from each frame in the frame sequence and/or any other information associated with the frame sequence (e.g., video content, audio content, metadata, etc.).

In some examples, the content analysis server 110 generates the frame sequences for each multimedia stream based on information about each frame (e.g., video content, audio content, metadata, fingerprint, etc.).

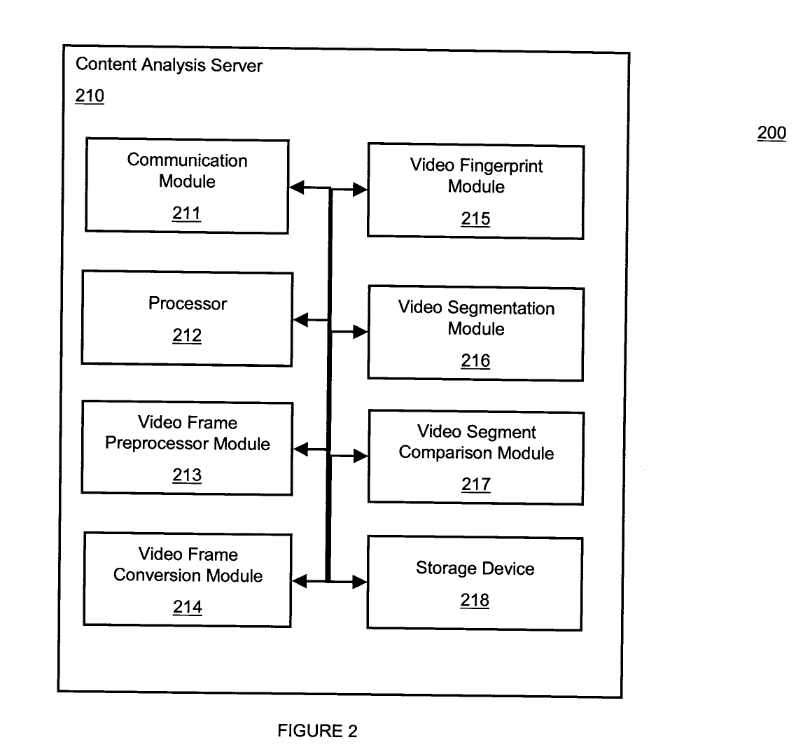

FIG. 2 illustrates a functional block diagram of an exemplary content analysis server 210 in a system 200. The content analysis server 210 includes a communication module 211, a processor 212, a video frame preprocessor module 213, a video frame conversion module 214, a video fingerprint module 215, a video segmentation module 216, a video segment conversion module 217, and a storage device 218.

The communication module 211 receives information for and/or transmits information from the content analysis server 210. The processor 212 processes requests for comparison of multimedia streams (e.g., request from a user, automated request from a schedule server, etc.) and instructs the communication module 211 to request and/or receive multimedia streams. The video frame preprocessor module 213 preprocesses multimedia streams (e.g., remove black border, insert stable borders, resize, reduce, selects key frame, groups frames together, etc.). The video frame conversion module 214 converts the multimedia streams (e.g., luminance normalization, RGB to Color9, etc.). The video fingerprint module 215 generates a fingerprint for each key frame selection (e.g., each frame is its own key frame selection, a group of frames have a key frame selection, etc.) in a multimedia stream. The video segmentation module 216 segments frame sequences for each multimedia stream together based on the fingerprints for each key frame selection. The video segment comparison module 217 compares the frame sequences for multimedia streams to identify similar frame sequences between the multimedia streams (e.g., by comparing the fingerprints of each key frame selection of the frame sequences, by comparing the fingerprints of each frame in the frame sequences, etc.). The storage device 218 stores a request, a multimedia stream, a fingerprint, a frame selection, a frame sequence, a comparison of the frame sequences, and/or any other information associated with the comparison of frame sequences.

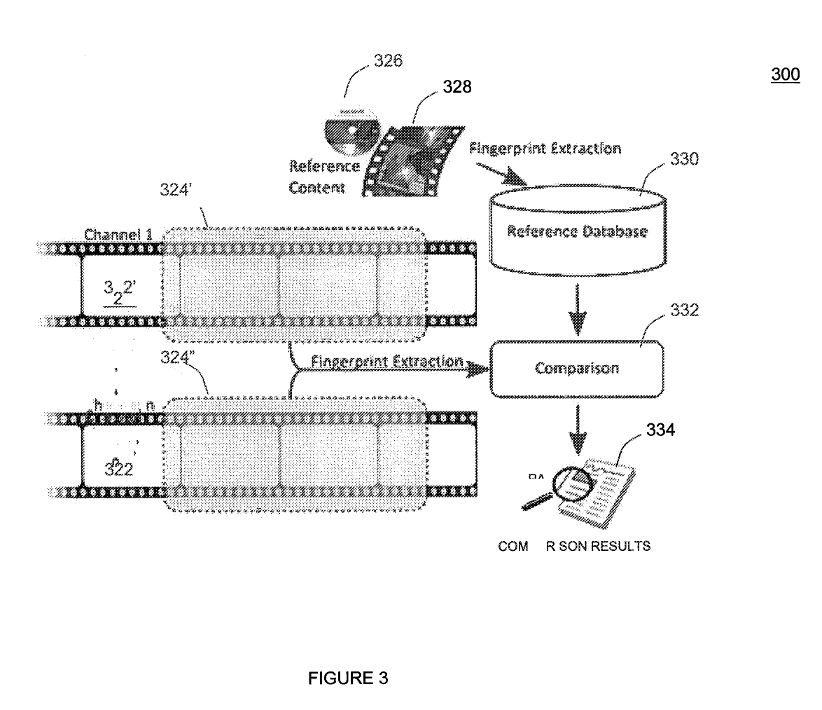

FIG. 3 illustrates an exemplary block diagram of an exemplary multi-channel video comparing process 300 in the system 100 of FIG. 1. The content analysis server 110 receives one or more channels 1 322′ through n 322″ (generally referred to as channel 322) and reference content 326. The content analysis server 110 identifies groups of similar frames 328 of the reference content 326 and generates a representative fingerprint for each group. In some embodiments, the content analysis server 110 includes a reference database 330 to store the one or more fingerprints associated with the reference content 326. The content analysis server 110 identifies groups of similar frames 324′ and 324″ (generally referred to as group 324) for the multimedia stream on each channel 322. The content analysis server 110 generates a representative fingerprint for each group 324 in each multimedia stream. The content analysis server 110 compares (332) the representative fingerprint for the groups 324 of each multimedia stream with the reference fingerprints determined from the reference content 326, as may be stored in the reference database 330. The content analysis server 110 generates (334) results based on the comparison of the fingerprints. In some embodiments, the results include statistics determined from the comparison (e.g., frame similarity ratio, frame group similarity ratio, etc.).

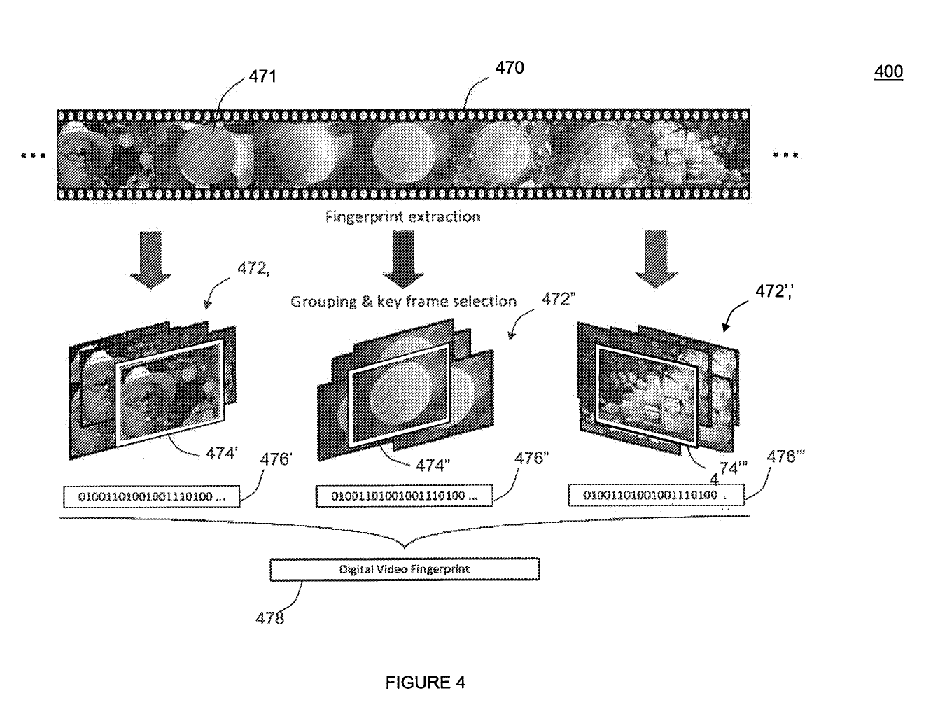

FIG. 4 illustrates an exemplary flow diagram 400 of a generation of a digital video fingerprint. The content analysis units fetch the recorded data chunks (e.g., multimedia content) from the signal buffer units directly and extract fingerprints prior to the analysis. The content analysis server 110 of FIG. 1 receives one or more video (and more generally audiovisual) clips or segments 470, each including a respective sequence of image frames 471. Video image frames are highly redundant, with groups frames varying from each other according to different shots of the video segment 470. In the exemplary video segment 470, sampled frames of the video segment are grouped according to shot: a first shot 472′, a second shot 472″, and a third shot 472″. A representative frame, also referred to as a key frame 474′, 474″, 474′″ (generally 474) is selected for each of the different shots 472′, 472″, 472″ (generally 472). The content analysis server 100 determines a respective digital signature 476′, 476″, 476′″ (generally 476) for each of the different key frames 474. The group of digital signatures 476 for the key frames 474 together represent a digital video fingerprint 478 of the exemplary video segment 470.

In some examples, a fingerprint is also referred to as a descriptor. Each fingerprint can be a representation of a frame and/or a group of frames. The fingerprint can be derived from the content of the frame (e.g., function of the colors and/or intensity of an image, derivative of the parts of an image, addition of all intensity value, average of color values, mode of luminance value, spatial frequency value). The fingerprint can be an integer (e.g., 345, 523) and/or a combination of numbers, such as a matrix or vector (e.g., [a, b], [x, y, z]). For example, the fingerprint is a vector defined by [x, y, z] where x is luminance, y is chrominance, and z is spatial frequency for the frame.

In some embodiments, shots are differentiated according to fingerprint values. For example in a vector space, fingerprints determined from frames of the same shot will differ from fingerprints of neighboring frames of the same shot by a relatively small distance. In a transition to a different shot, the fingerprints of a next group of frames differ by a greater distance. Thus, shots can be distinguished according to their fingerprints differing by more than some threshold value.

Thus, fingerprints determined from frames of a first shot 472′ can be used to group or otherwise identify those frames as being related to the first shot. Similarly, fingerprints of subsequent shots can be used to group or otherwise identify subsequent shots 472″, 472″. A representative frame, or key frame 474′, 474″, 474′″ can be selected for each shot 472. In some embodiments, the key frame is statistically selected from the fingerprints of the group of frames in the same shot (e.g., an average or centroid).

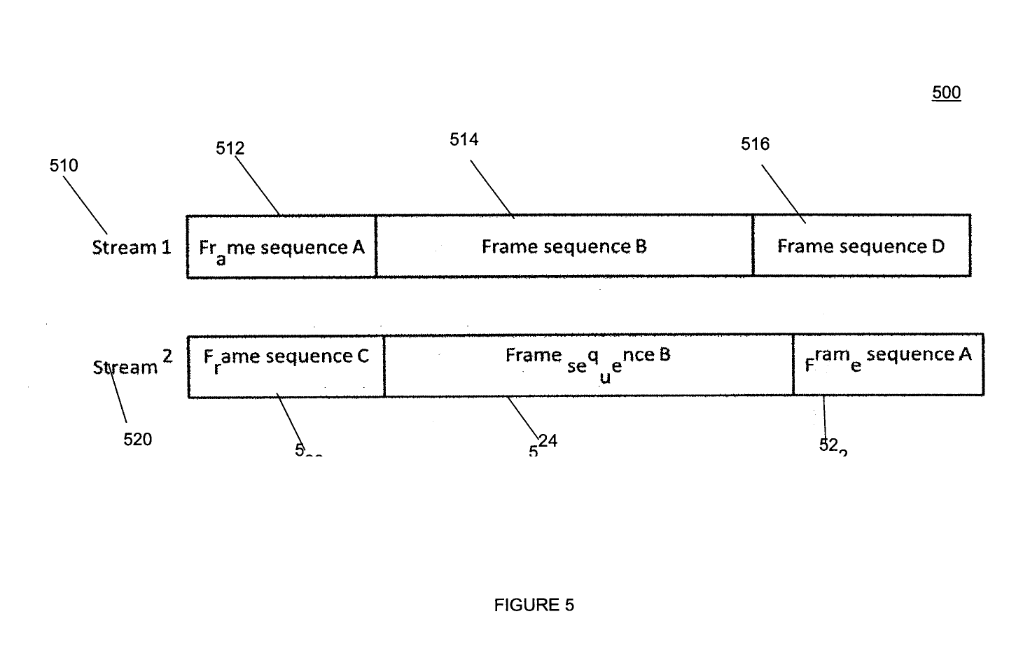

FIG. 5 illustrates an exemplary result 500 of a comparison of two video streams 510 and 520 by the content analysis server 110 of FIG. 1. The content analysis server 110 splits each of the video streams 510 and 520 into frame sequences 512, 514, 516, 523, 524, and 522, respectively, based on key frames. The content analysis server 110 compares the frame sequences to find similar frame sequences between the video streams 510 and 520. Stream 1 510 includes frame sequences A 512, B 514, and C 516. Stream 2 520 includes frame sequences C 523, B 524, and A 522. The content analysis server matches frame sequence B 514 in stream 1 510 to the frame sequence B 524 in stream 2 520.

For example, the communication module 211 of FIG. 2 receives a request from a user to compare two digital video discs (DVD). The first DVD is the European version of a movie titled “All Dogs Love the Park.” The second DVD is the United States version of the movie titled “All Dogs Love the Park.” The processor 212 processes the request from the user and instructs the communication module 211 to request and/or receive the multimedia streams from the two DVDs (i.e., transmitting a play command to the DVD player devices that have the two DVDs). The video frame preprocessor module 213 preprocesses the two multimedia streams (e.g., remove black border, insert stable borders, resize, reduce, identifies a key frame selection, etc.). The video frame conversion module 214 converts the two multimedia streams (e.g., luminance normalization, RGB to Color9, etc.). The video fingerprint module 215 generates a fingerprint for each key frame selection (e.g., each frame is its own key frame selection, a group of frames have a key frame selection, etc.) in the two multimedia streams. The video segmentation module 216 segments the frame sequences for each multimedia stream. The video segment comparison module 217 compares a signature for each frame sequence for the multimedia stream to identify similar frame sequences. Table 1 illustrates an exemplary comparison process for the two multimedia streams illustrated in FIG. 5.

TABLE 1
Exemplary Comparison Process

| Multimedia Stream 1 510 | Multimedia Stream 2 520 | Result |
|---|---|---|
| Frame Sequence A 512 | Frame Sequence C 523 | Different |
| Frame Sequence A 512 | Frame Sequence B 524 | Different |
| Frame Sequence A 512 | Frame Sequence A 522 | Similar |
| Frame Sequence B 514 | Frame Sequence C 523 | Different |
| Frame Sequence B 514 | Frame Sequence B 524 | Similar |
| Frame Sequence B 514 | Frame Sequence A 522 | Different |
| Frame Sequence D 516 | Frame Sequence C 523 | Different |
| Frame Sequence D 516 | Frame Sequence B 524 | Different |
| Frame Sequence D 516 | Frame Sequence A 522 | Different |

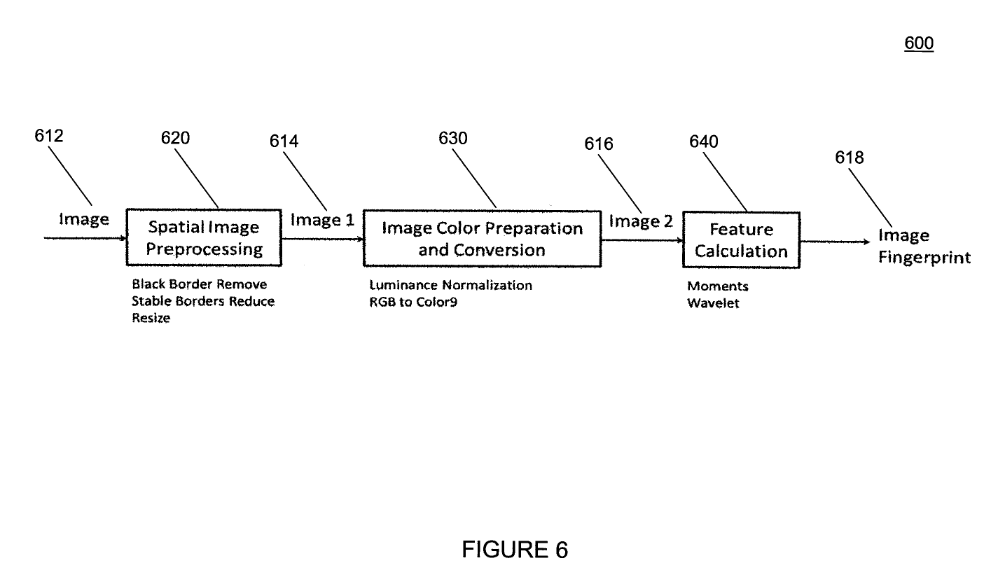

FIG. 6 illustrates an exemplary flow chart 600 of a generation of a fingerprint for an image 612 by the content analysis server 210 of FIG. 2. The communication module 211 receives the image 612 and communicates the image 612 to the video frame preprocessor module 213. The video frame preprocessor module 213 preprocesses (620) (e.g., spatial image preprocessing) the image to form a preprocessed image 614. The video frame conversion module 214 converts (630) (e.g., image color preparation and conversation) the preprocessed image 614 to form a converted image 616. The video fingerprint module 215 generates (640) (e.g., feature calculation) an image fingerprint 618 of the converted image 616.

In some examples, the image is a single video frame. The content analysis server 210 can generate the fingerprint 618 for every frame in a multimedia stream and/or every key frame in a group of frames. In other words, the image 612 can be a key frame for a group of frames. In some embodiments, the content analysis server 210 takes advantage of a high level of redundancy and generates fingerprints for every n^{th} frame (e.g., n=2).

In other examples, the fingerprint 618 is also referred to as a descriptor. Each multimedia stream has an associated list of descriptors that are compared by the content analysis server 210. Each descriptor can include a multi-level visual fingerprint that represents the visual information of a video frame and/or a group of video frames.

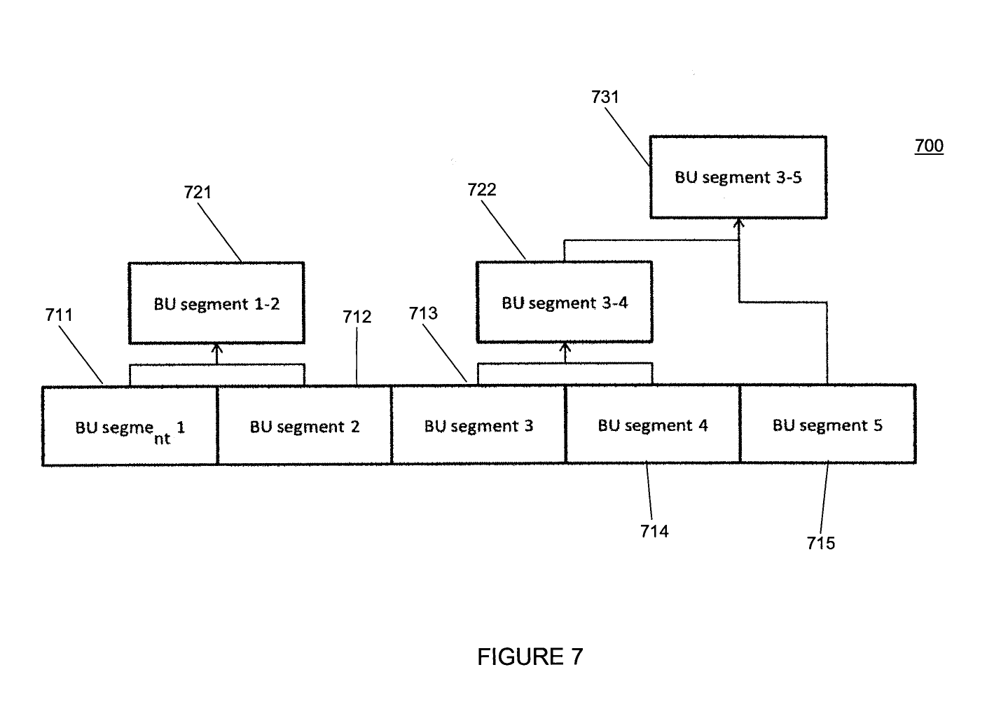

FIG. 7 illustrates an exemplary block process diagram 700 of a grouping of frames (also referred to as segments) by the content analysis server 210 of FIG. 2. Each segment 1 711, 2 712, 3 713, 4 714, and 5 715 includes a fingerprint for the segment. Other indicia related to the segment can be associated with the fingerprint, such as a frame number, a reference time, a segment start reference, stop reference, and/or segment length. The video segmentation module 216 compares the fingerprints for the adjacent segments to each other (e.g., fingerprint for segment 1 711 compared to fingerprint for segment 2 712, etc.). If the difference between the fingerprints is below a predetermined and/or a dynamically set segmentation threshold, the video segmentation module 216 merges the adjacent segments. If the difference between the fingerprints is at or above the predetermined and/or a dynamically set segmentation threshold, the video segmentation module 216 does not merge the adjacent segments.

In the example, the video segmentation module 216 compares the fingerprints for segment 1 711 and 2 712 and merges the two segments into segment 1-2 721 based on the difference between the fingerprints of the two segments being less than a threshold value. The video segmentation module 216 compares the fingerprint for segments 2 712 and 3 713 and does not merge the segments be cause the difference between the two fingerprints is greater than the threshold value. The video segmentation module 216 compares the fingerprints for segment 3 713 and 4 714 and merges the two segments into segment 3-4 722 based on the difference between the fingerprints of the two segments. The video segmentation module 216 compares the fingerprints for segment 3-4 722 and 5 715 and merges the two segments into segment 3-5 731 based on the difference between the fingerprints of the two segments. The video segmentation module 216 can further compare the fingerprints for the other adjacent segments (e.g., segment 2 712 to segment 3 713, segment 1-2 721 to segment 3 713, etc.). The video segmentation module 216 completes the merging process when no further fingerprint comparisons are below the segmentation threshold. Thus, selection of a comparison or difference threshold for the comparisons can be used to control the storage and/or processing requirements.

In other examples, each segment 1 711, 2 712, 3 713, 4 714, and 5 715 includes a fingerprint for a key frame in a group of frames and/or a link to the group of frames. In some examples, each segment 1 711, 2 712, 3 713, 4 714, and 5 715 includes a fingerprint for a key frame in a group of frames and/or the group of frames.

In some examples, the video segment comparison module 217 identifies similar segments (e.g., merged segments, individual segments, segments grouped by time, etc.). The identification of the similar segments can include one or more of the following identification processes: (i) brute-force process (i.e., compare every segment with every other segment); (ii) adaptive windowing process; and (iii) clustering process.

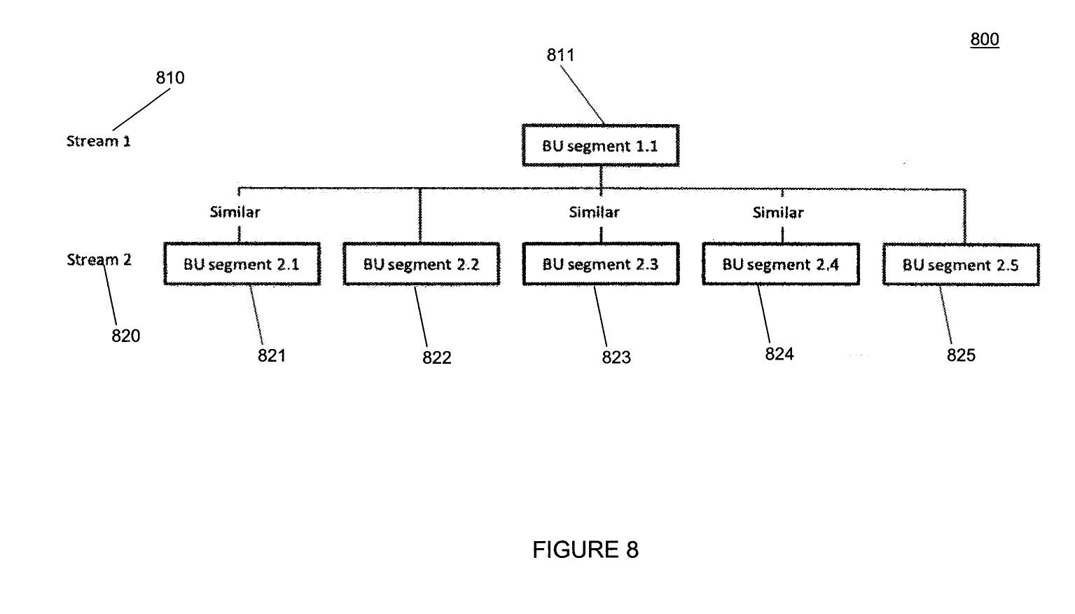

FIG. 8 illustrates an exemplary block diagram of a brute-force comparison process 800 via the content analysis server 210 of FIG. 2. The comparison process 800 is comparing segments of stream 1 810 with segments of stream 2 820. The video segment comparison module 217 compares Segment 1.1 811 with each of the segments of stream 2 820 as illustrated in Table 2. The segments are similar if the difference between the signatures of the compared segments is less than a comparison threshold (e.g., difference within a range 3<difference<−3, absolute difference−|difference|, etc.). The comparison threshold for the segments illustrated in Table 2 is four. The comparison threshold can be predetermined and/or dynamically configured (e.g., a percentage of the total number of segments in a stream, ratio of segments between the streams, etc.).

TABLE 2
Exemplary Comparison Process

| | | | | Absolute | |
|---|---|---|---|---|---|
| Multimedia | Sig- | Multimedia | Sig- | Differ- | |
| Stream 1 810 | nature | Stream 2 820 | nature | ence | Result |
| Segment 1.1 811 | 59 | Segment 2.1 821 | 56 | 3 | Similar |
| Segment 1.1 811 | 59 | Segment 2.2 822 | 75 | 6 | Different |
| Segment 1.1 811 | 59 | Segment 2.3 823 | 57 | 2 | Similar |
| Segment 1.1 811 | 59 | Segment 2.4 824 | 60 | 1 | Similar |
| Segment 1.1 811 | 59 | Segment 2.5 825 | 32 | 27 | Different |

The video segment comparison module 217 adds the pair of similar segments and the difference between the signatures to a similarsegment_list as illustrated in Table 3.

TABLE 3
Exemplary Similar_Segment_List

| | | Absolute |
|---|---|---|
| Segment | Segment | Difference |
| Segment 1.1 811 | Segment 2.1 821 | 3 |
| Segment 1.1 811 | Segment 2.3 823 | 2 |
| Segment 1.1 811 | Segment 2.4 824 | 1 |

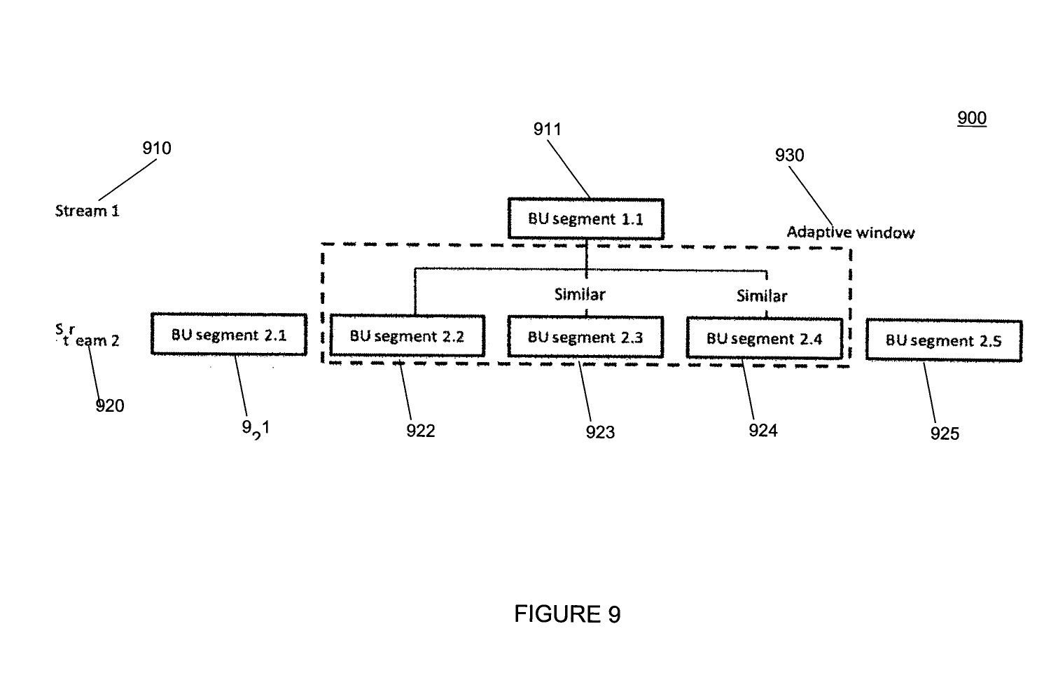

FIG. 9 illustrates an exemplary block diagram of an adaptive window comparison process 900 via the content analysis server 210 of FIG. 2. The adaptive window comparison process 900 analyzes stream 1 910 and stream 2 920. The stream 1 910 includes segment 1.1 911, and the stream 2 920 includes segments 2.1 921, 2.2 922, 2.3 923, 2.4 924, and 2.5 925. The video segment comparison module 217 compares the segment 1.1 911 in the stream 1 910 to each segment in the stream 2 920 that falls within an adaptive window 930. In other words, the segment comparison module 217 compares segment 1.1 911 to the segments 2.2 922, 2.3 923, and 2.4 924. The video segment comparison module 217 adds the pair of similar segments and the difference between the signatures to the similar_segmentlist. For example, the adaptive window comparison process 900 is utilized for multimedia streams over thirty minutes in length and the brute-force comparison process 800 is utilized for multimedia streams under thirty minutes in length. As another example, the adaptive window comparison process 900 is utilized for multimedia streams over five minutes in length and the brute-force comparison process 800 is utilized for multimedia streams under five minutes in length.

In other embodiments, the adaptive window 930 can grow and/or shrink based on the matches and/or other information associated with the multimedia streams (e.g., size, content type, etc.). For example, if the video segment comparison module 217 does not identify any matches or below a match threshold number for a segment within the adaptive window 930, the size of the adaptive window 930 can be increased by a predetermined size (e.g., from the size of three to the size of five, from the size of ten to the size of twenty, etc.) and/or a dynamically generated size (e.g., percentage of total number of segments, ratio of the number of segments in each stream, etc.). After the video segment comparison module 217 identifies the match threshold number and/or exceeds a maximum size for the adaptive window 930, the size of the adaptive window 930 can be reset to the initial size and/or increased based on the size of the adaptive window at the time of the match.

In some embodiments, the initial size of the adaptive window is predetermined (e.g., five hundred segments, three segments on either side of the corresponding time in the multimedia streams, five segments on either side of the respective location with respect to the last match in the multimedia streams, etc.) and/or dynamically generated (e.g., ⅓ length of multimedia content, ratio based on the number of segments in each multimedia stream, percentage of segments in the first multimedia stream, etc.). The initial start location for the adaptive window can be predetermined (e.g., same time in both multimedia streams, same frame number for the key frame, etc.) and/or dynamically generated (e.g., percentage size match of the respective segments, respective frame locations from the last match, etc.).

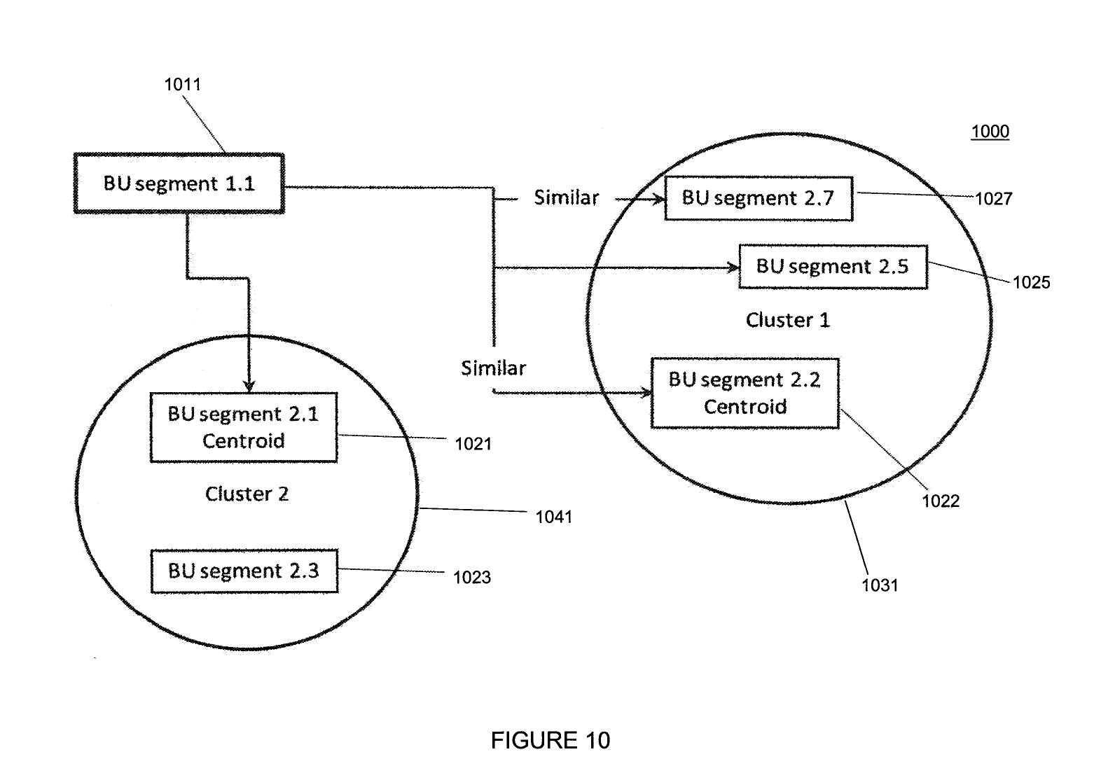

FIG. 10 illustrates an exemplary block diagram of a clustering comparison process 1000 via the content analysis server 210 of FIG. 2. The adaptive window comparison process 1000 analyzes stream 1 and stream 2. The stream 1 includes segment 1.1 1011, and the stream 2 includes segments 2.1 1021, 2.2 1022, 2.3 1023, 2.5 1025, and 275 1027. The video segment comparison module 217 clusters the segments of stream 2 together, cluster 1 1031 and cluster 2 1041 according to their fingerprints. For each cluster, the video segment comparison module 217 identifies a representative segment, such as that segment having a fingerprint that corresponds to a centroid of the cluster of fingerprints for that cluster. The centroid for cluster 1 1031 is segment 2.2 1022, the centroid for cluster 2 1041 is segment 2.1 1021.

The video segment comparison module 217 compares the segment 1.1 1011 with the centroid segments 2.1 1021 and 2.2 1022 for each cluster 1 1031 and 2 1041, respectively. If a centroid segment 2.1 1021 or 2.2 1022 is similar to the segment 1.1 1011, the video segment comparison module 217 compares every segment in the cluster of the similar centroid segment with the segment 1.1 1011. The video segment comparison module 217 adds any pairs of similar segments and the difference between the signatures to the similar_segment_list.

In some embodiments, one or more of the different statistics can be used. For example, the brute-force comparison process 800 is utilized for multimedia streams under thirty minutes in length, the adaptive window comparison process 900 is utilized for multimedia streams between thirty-sixty minutes in length, and the clustering comparison process 1000 is used for multimedia streams over sixty minutes in length.

Although the clustering comparison process 1000 as described in FIG. 10 utilizes a centroid, the clustering process 1000 can utilize any type of statistical function to identify a representative segment for comparison for the cluster (e.g., average, mean, median, histogram, moment, variance, quartiles, etc.). In some embodiments, the video segmentation module 216 clusters segments together by determining the difference between the fingerprints of the segments for a multimedia stream. For the clustering process, all or part of the segments in a multimedia stream can be analyzed (e.g., brute-force analysis, adaptive window analysis, etc.).

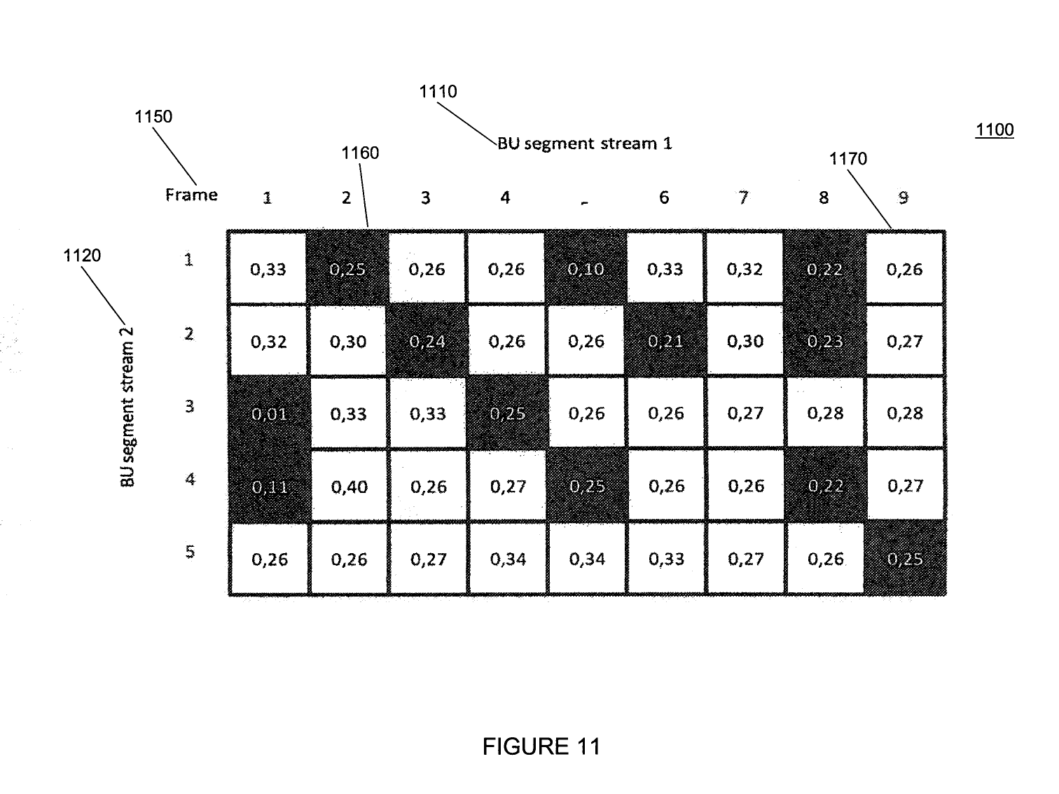

FIG. 11 illustrates an exemplary block diagram 1100 of an identification of similar frame sequences via the content analysis server 210 of FIG. 2. The block diagram 1100 illustrates a difference matrix generated by the pairs of similar segments and the difference between the signatures in the similar_segment_list. The block diagram 100 depicts frames 1-9 1150 (i.e., nine frames) of segment stream 1 1110 and frames 1-5 1120 (i.e., five frames) of segment stream 2 1120. In some examples, the frames in the difference matrix are key frames for an individual frame and/or a group of frames.

The video segment comparison 217 can generate the difference matrix based on the similar_segment_list. As illustrated in FIG. 11, if the difference between the two frames is below a detailed comparison threshold (in this example, 0.26), the block is black (e.g., 1160). Furthermore, if the difference between the two frames is not below the detailed threshold, the block is white (e.g., 1170).

The video segment comparison module 217 can analyze the diagonals of the difference matrix to detect a sequence of similar frames. The video segment comparison module 217 can find the longest diagonal of adjacent similar frames (in this example, the diagonal (1,2)-(4,5) is the longest) and/or find the diagonal of adjacent similar frames with the smallest average difference (in this example, the diagonal (1,5)-(2,6) has the smallest average difference) to identify a set of similar frame sequences. This comparison process can utilize one or both of these calculations to detect the best sequence of similar frames (e.g., use both and average the length times the average and take the highest result to identify the best sequence of similar frames). This comparison process can be repeated by the video segment comparison module 217 until each segment of stream 1 is compared to its similar segments of stream 2.

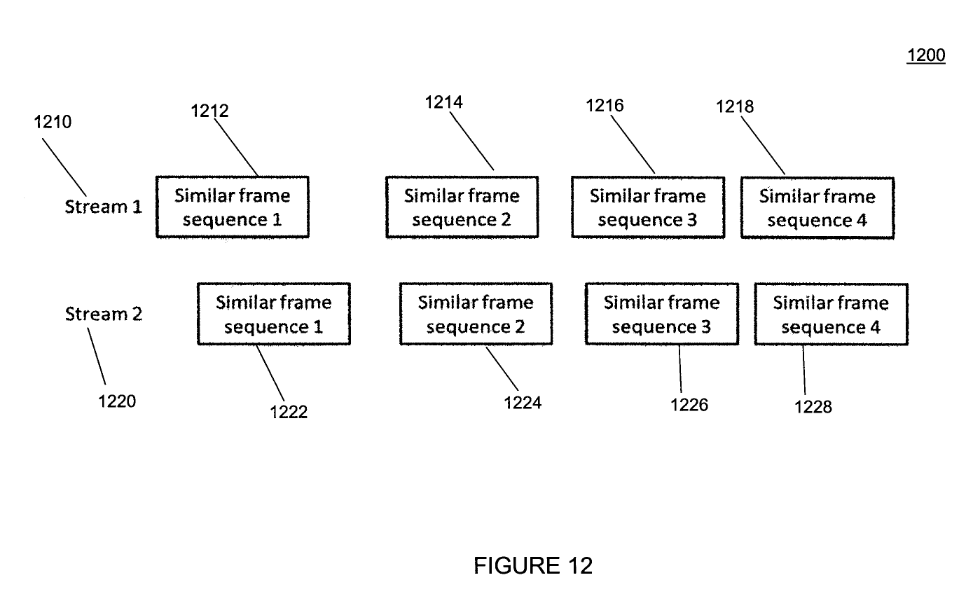

FIG. 12 illustrates an exemplary block diagram 1200 of similar frame sequences identified by the content analysis server 210 of FIG. 2. Based on the analysis of the diagonals, the video segment comparison module 217 identifies a set of similar frame sequences for stream 1 1210 and stream 2 1220. The stream 1 1210 includes frame sequences 1 1212, 2 1214, 3 1216, and 4 1218 that are respectively similar to frame sequences 1 1222, 2 1224, 3 1226, and 4 1228 of stream 2 1220. As illustrated in FIG. 12, the streams 1 1210 and 2 1220 can include unmatched or otherwise dissimilar frame sequences (i.e., space between the similar frame sequences).

In some embodiments, the video segment comparison module 217 identifies similar frame sequences for unmatched frame sequences, if any. The unmatched frame sequences can also be referred to as holes. The identification of the similar frame sequences to unmatched frame sequence can be based on a hold comparison threshold that is predetermined and/or dynamically generated. The video segment comparison module 217 can repeat the identification of similar frame sequences for unmatched frame sequences until all unmatched frame sequences are matched and/or can identify the unmatched frame sequences as unmatched (i.e., no match is found). The identification of the similar segments can include one or more of the following identification processes: (i) brute-force process; (ii) adaptive windowing process; (iii) extension process; and (iv) hole matching process.

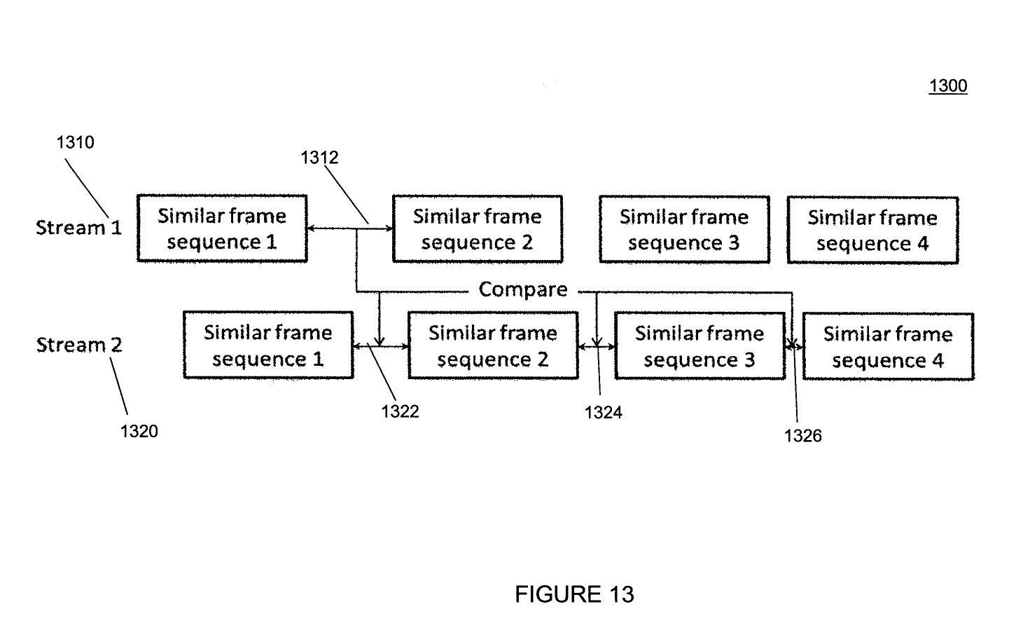

FIG. 13 illustrates an exemplary block diagram of a brute force identification process 1300 via the content analysis server 210 of FIG. 2. The brute force identification process 1300 analyzes streams 1 1310 and 2 1320. The stream 1 1310 includes hole 1312, and the stream 2 1320 includes holes 1322, 1324, and 1326. For the identified hole 1312 in stream 1 1310, the video segment comparison module 217 compares the hole 1312 with all of the holes in stream 2 1320. In other words, the hole 1312 is compared to the holes 1322, 1324, and 1326. The video segment comparison module 217 can compare the holes by determining the difference between the signatures for the compares hold, and determining if the difference is below the hold comparison threshold. The video segment comparison module 217 can match the holes with the best result (e.g., lowest difference between the signatures, lowest difference between frame numbers, etc.).

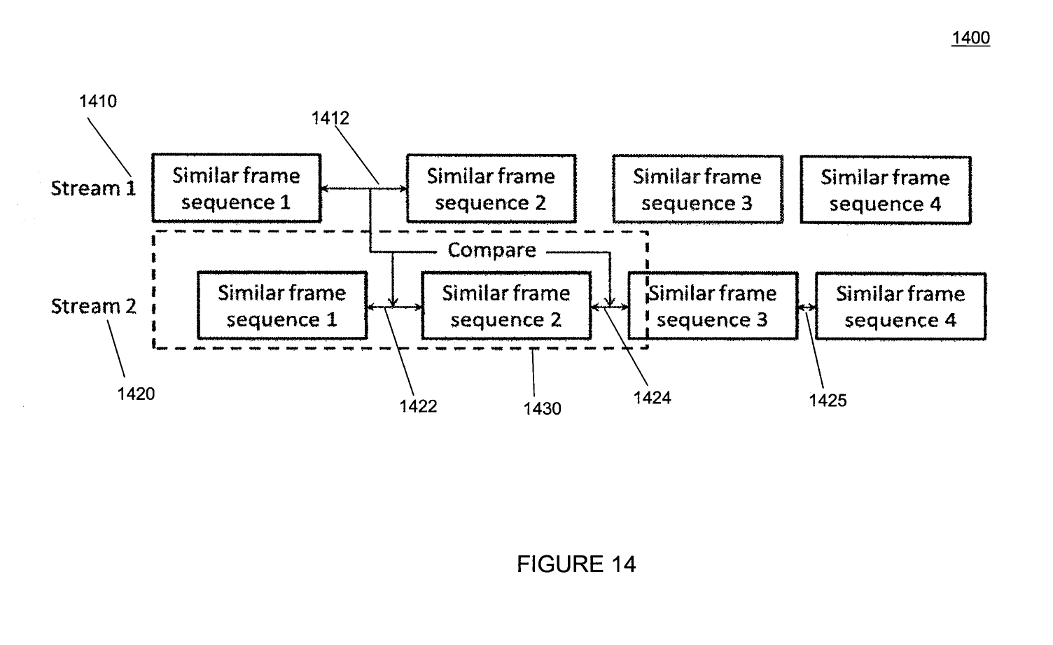

FIG. 14 illustrates an exemplary block diagram of an adaptive window identification process 1400 via the content analysis server 210 of FIG. 2. The adaptive window identification process 1400 analyzes streams 1 1410 and 2 1420. The stream 1 1410 includes a target hole 1412, and the stream 2 1420 includes holes 1422, 1424 and 1425, of which holes 1422 and 1424 fall in the adaptive window 1430. For the identified target hole 1412 in stream 1 1410, the video segment comparison module 217 compares the hole 1412 with all of the holes in stream 2 1420 that fall within the adaptive window 1430. In other words, the hole 1412 is compared to the holes 1422 and 1424. The video segment comparison module 217 can compare the holes by determining the difference between the signatures for the compares hold, and determining if the difference is below the hold comparison threshold. The video segment comparison module 217 can match the holes with the best result (e.g., lowest difference between the signatures, lowest difference between frame numbers, etc.). The initial size of the adaptive window 1430 can be predetermined and/or dynamically generated as described herein. The size of the adaptive window 1430 can be modified as described herein.

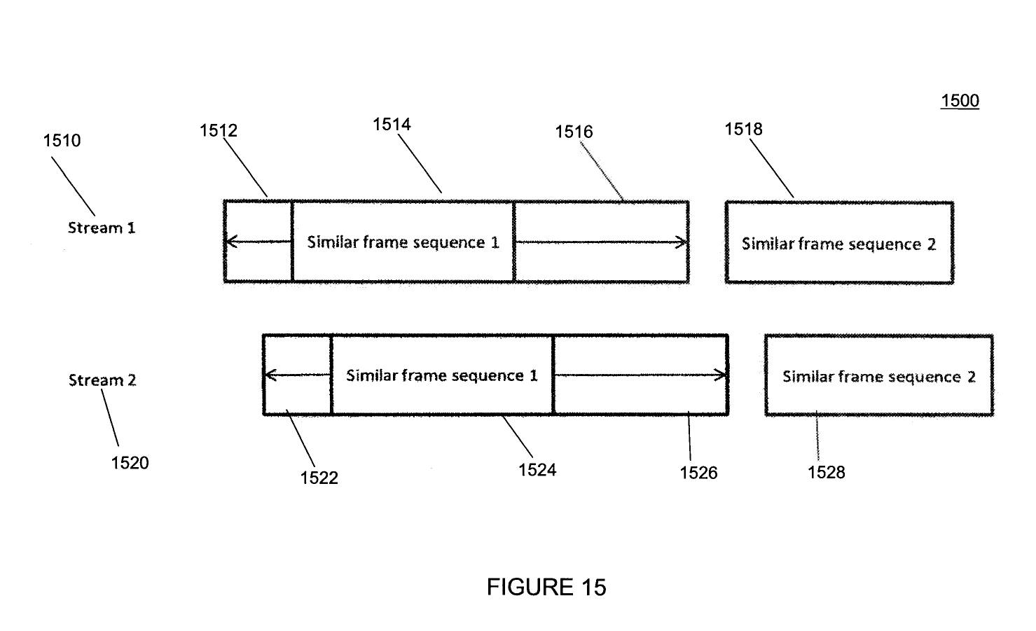

FIG. 15 illustrates an exemplary block diagram of an extension identification process 1500 via the content analysis server 210 of FIG. 2. The extension identification process 1500 analyzes streams 1 1510 and 2 1520. The stream 1 1510 includes similar frame sequences 1 1514 and 2 1518 and extensions 1512 and 1516, and the stream 2 1520 includes similar frame sequences 1 1524 and 2 1528 and extensions 1522 and 1526. The video segment comparison module 217 can extend similar frame sequences (in this example, similar frame sequences 1 1514 and 1 1524) to the left and/or to the right of their existing start and/or stop locations.

The extension of the similar frame sequences can be based on the difference of the signatures for the extended frames and the hole comparison threshold (e.g., the difference of the signatures for each extended frame is less than the hole comparison threshold). As illustrated, the similar frame sequence 1 1514 and 1 1524 are extended to the left 1512 and 1522 and to the right 1516 and 1526, respectively. In other words, the video segment comparison module 217 can determine the difference in the signatures for each frame to the right and/or to the left of the respective similar frame sequences. If the difference is less than the hole comparison threshold, the video segment comparison module 217 extends the similar frame sequences in the appropriate direction (i.e., left or right).

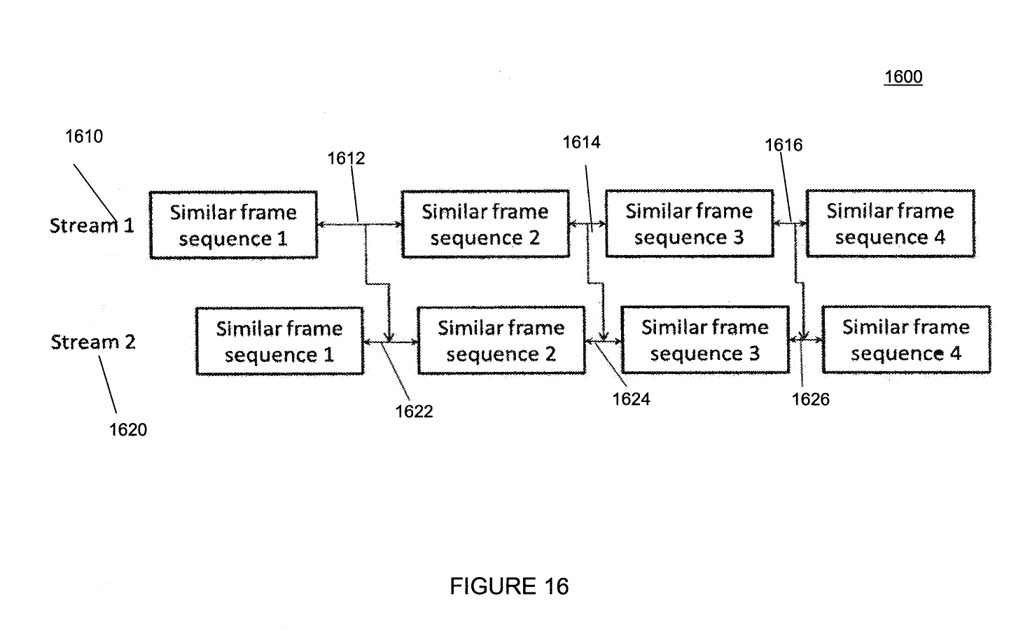

FIG. 16 illustrates an exemplary block diagram of a hole matching identification process 1600 via the content analysis server 210 of FIG. 2. The adaptive hole matching identification process 1600 analyzes streams 1 1610 and 2 1620. The stream 1 1610 includes holes 1612, 1614, and 1616 and similar frame sequences 1, 2, 3, and 4. The stream 2 1620 includes holes 1622, 1624, and 1626 and similar frame sequences 1, 2, 3, and 4. For each identified hole in stream 1 1610, the video segment comparison module 217 compares the hole with a corresponding hole between two adjacent similar frame sequences. In other words, the hole 1612 is compared to the hole 1622 because the holes 1612 and 1622 are between the similar frame sequences 1 and 2 in streams 1 1610 and 2 1610, respectively. Furthermore, the hole 1614 is compared to the hole 1624 because the holes 1614 and 1624 are between the similar frame sequences 2 and 3 in streams 1 1610 and 2 1610, respectively. The video segment comparison module 217 can compare the holes by determining the difference between the signatures for the compares hold, and determining if the difference is below the hold comparison threshold. If the difference is below the hold comparison threshold, the holes match.

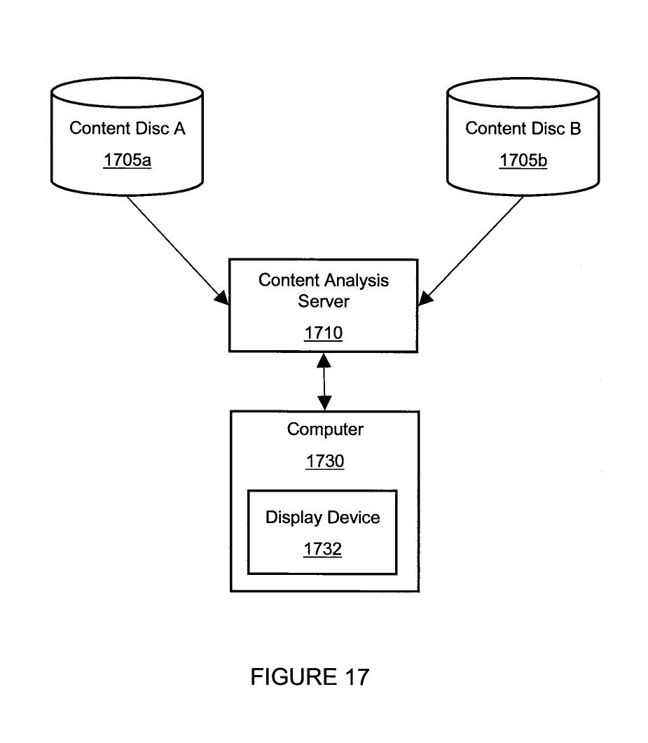

FIG. 17 illustrates a functional block diagram of an exemplary system 1700. The system 1700 includes content discs A 1705a and B 1705b, a content analysis server 1710, and a computer 1730. The computer 1730 includes a display device 1732. The content analysis server 1710 compares the content discs A 1705a and B 1705b to determine the differences between the multimedia content on each disc. The content analysis server 1710 can generate a report of the differences between the multimedia content on each disc and transmit the report to the computer 1730. The computer 1730 can display the report on the display device 1732 (e.g., monitor, projector, etc.). The report can be utilized by a user to determine ratings for different versions of a movie (e.g., master from China and copy from Hong Kong, etc.), compare commercials between different sources, compare news multimedia content between different sources (e.g., compare broadcast news video from network A and network B, compare online news video and to broadcast television news video, etc.), compare multimedia content from political campaigns, and/or any comparison of multimedia content (e.g., video, audio, text, etc.). For example, the system 1700 can be utilized to compare multimedia content from multiple sources (e.g., difference countries, different releases, etc.).

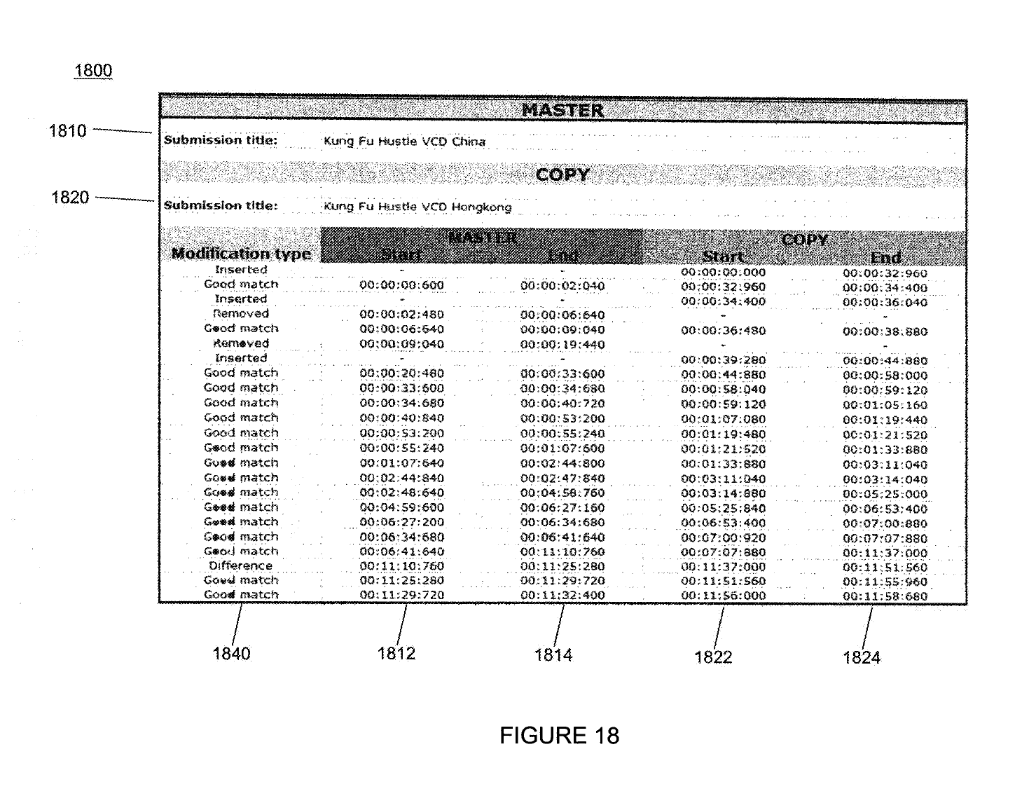

FIG. 18 illustrates an exemplary report 1800 generated by the system 1700 of FIG. 17. The report 1800 includes submission titles 1810 and 1820, a modification type column 1840, a master start time column 1812, a master end time column 1814, a copy start time column 1822, and a copy end time column 1824. The report 1800 illustrates the results of an comparison analysis of disc A 1705a (in this example, the submission title 1810 is Kung Fu Hustle VCD China) and B 1705b (in this example, the submission title 1820 is Kung Fu Hustle VCD Hongkong). As illustrated in the report 1800 parts of the master and copy are good matches, parts are inserted in one, parts are removed in one, and there are different parts. The comparisons can be performed on a segment-by-segment basis, the start and end times corresponding to each segment. The user and/or an automated system can analyze the report 1800.

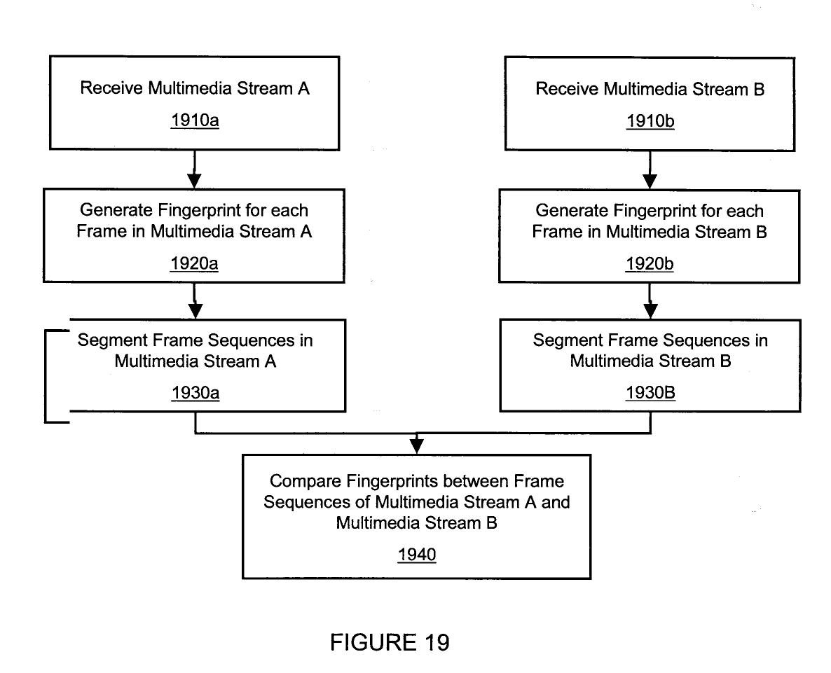

FIG. 19 illustrates an exemplary flow chart 1900 for comparing fingerprints between frame sequences utilizing the system 200 of FIG. 2. The communication module 211 receives (1910a) multimedia stream A and receives (1910b) multimedia stream 13. The video fingerprint module 215 generates (1920a) a fingerprint for each frame in the multimedia stream A and generates (1920b) a fingerprint for each frame in the multimedia stream B. The video segmentation module 216 segments (1930a) frame sequences in the multimedia stream A together based on the fingerprints for each frame. The video segmentation module 216 segments (1930b) frame sequences in the multimedia stream A together based on the fingerprints for each frame. The video segment comparison module 217 compares the segmented frame sequences for the multimedia streams A and B to identify similar frame sequences between the multimedia streams.

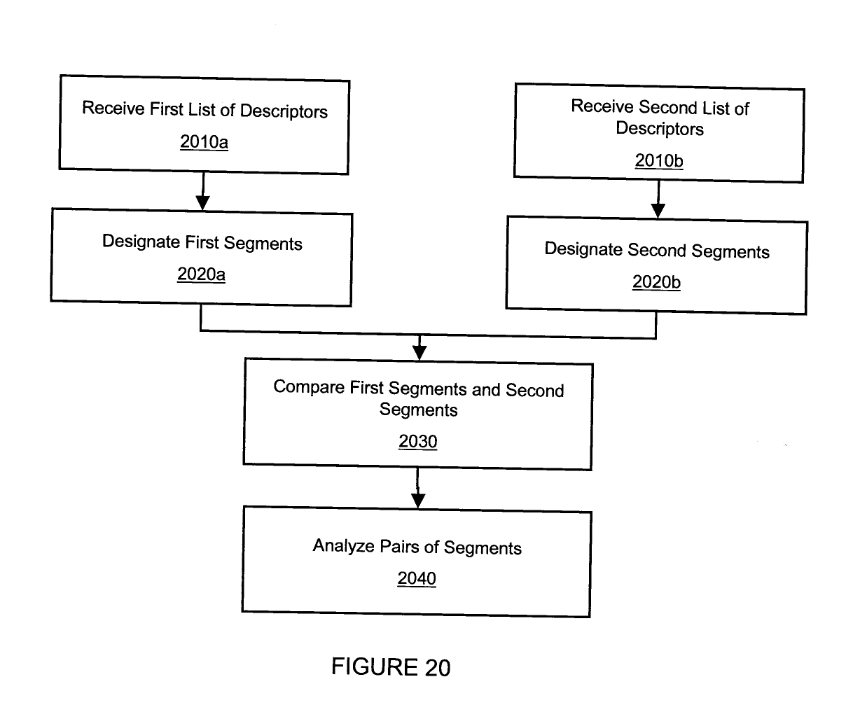

FIG. 20 illustrates an exemplary flow chart 2000 for comparing video sequences utilizing the system 200 of FIG. 2. The communication module 211 receives (2010a) a first list of descriptors pertaining to a plurality of first video frames. Each of the descriptors in the first line of descriptors represents visual information of a corresponding video frame of the plurality of first video frames. The communication module 211 receives (2010b) receives a second list of descriptors pertaining to a plurality of second video frames. Each of the descriptors in the second line of descriptors represents visual information of a corresponding video frame of the plurality of second video frames.

The video segmentation module 216 designates (2020a) first segments of the plurality of first video frames that are similar. Each segment of the first segments includes neighboring first video frames. The video segmentation module 216 designates (2020b) second segments of the plurality of second video frames that are similar. Each segment of the second segments includes neighboring second video frames.

The video segment comparison module 217 compares (2030) the first segments and the second segments. The video segment comparison module 217 analyzes (2040) the pairs of first and second segments based on the comparison of the first segments and the second segments to compare the first and second segments to a threshold value.

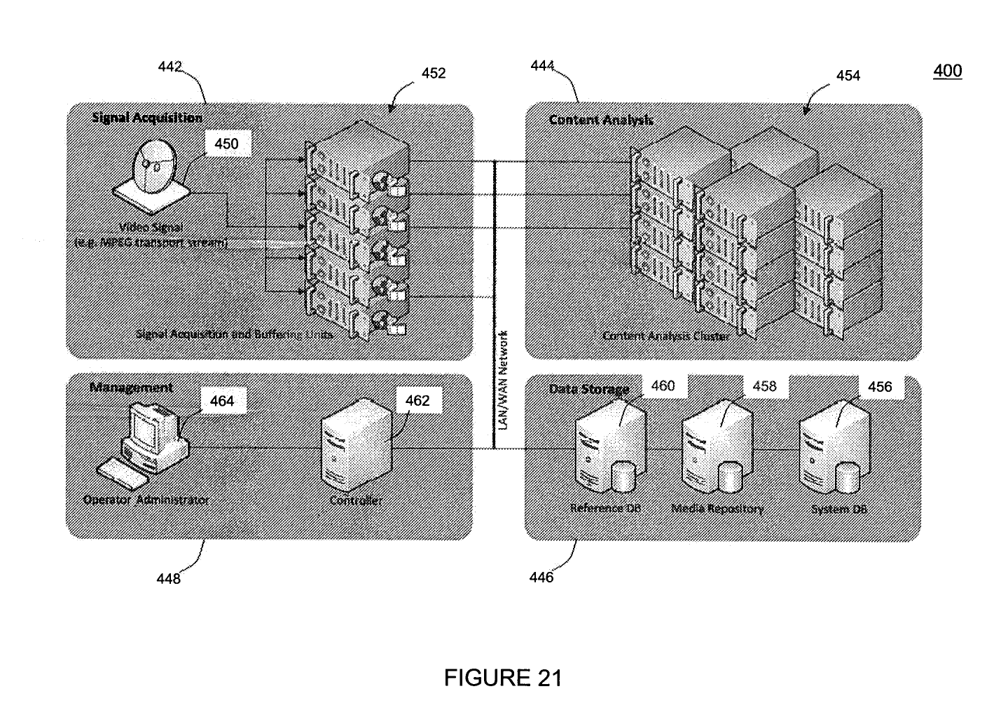

FIG. 21 illustrates a block diagram of an exemplary multi-channel video monitoring system 400. The system 400 includes (i) a signal, or media acquisition subsystem 442, (ii) a content analysis subsystem 444, (iii) a data storage subsystem 446, and (iv) a management subsystem 448.

The media acquisition subsystem 442 acquires one or more video signals 450. For each signal, the media acquisition subsystem 442 records it as data chunks on a number of signal buffer units 452. Depending on the use case, the buffer units 452 may perform fingerprint extraction as well, as described in more detail herein. Fingerprint extraction is described in more detail in International Patent Application Serial No. PCT/US2008/060164, entitled “Video Detection System And Methods,” incorporated herein by reference in its entirety. This can be useful in a remote capturing scenario in which the very compact fingerprints are transmitted over a communications medium, such as the Internet, from a distant capturing site to a centralized content analysis site. The video detection system and processes may also be integrated with existing signal acquisition solutions, as long as the recorded data is accessible through a network connection.

The fingerprint for each data chunk can be stored in a media repository 458 portion of the data storage subsystem 446. In some embodiments, the data storage subsystem 446 includes one or more of a system repository 456 and a reference repository 460. One or more of the repositories 456, 458, 460 of the data storage subsystem 446 can include one or more local hard-disk drives, network accessed hard-disk drives, optical storage units, random access memory (RAM) storage drives, and/or any combination thereof. One or more of the repositories 456, 458, 460 can include a database management system to facilitate storage and access of stored content. In some embodiments, the system 440 supports different SQL-based relational database systems through its database access layer, such as Oracle and Microsoft-SQL Server. Such a system database acts as a central repository for all metadata generated during operation, including processing, configuration, and status information.

In some embodiments, the media repository 458 is serves as the main payload data storage of the system 440 storing the fingerprints, along with their corresponding key frames. A low quality version of the processed footage associated with the stored fingerprints is also stored in the media repository 458. The media repository 458 can be implemented using one or more RAID systems that can be accessed as a networked file system.

Each of the data chunk can become an analysis task that is scheduled for processing by a controller 462 of the management subsystem 48. The controller 462 is primarily responsible for load balancing and distribution of jobs to the individual nodes in a content analysis cluster 454 of the content analysis subsystem 444. In at least some embodiments, the management subsystem 448 also includes an operator/administrator terminal, referred to generally as a front-end 464. The operator/administrator terminal 464 can be used to configure one or more elements of the video detection system 440. The operator/administrator terminal 464 can also be used to upload reference video content for comparison and to view and analyze results of the comparison.

The signal buffer units 452 can be implemented to operate around-the-clock without any user interaction necessary. In such embodiments, the continuous video data stream is captured, divided into manageable segments, or chunks, and stored on internal hard disks. The hard disk space can be implanted to function as a circular buffer. In this configuration, older stored data chunks can be moved to a separate long term storage unit for archival, freeing up space on the internal hard disk drives for storing new, incoming data chunks. Such storage management provides reliable, uninterrupted signal availability over very long periods of time (e.g., hours, days, weeks, etc.). The controller 462 is configured to ensure timely processing of all data chunks so that no data is lost. The signal acquisition units 452 are designed to operate without any network connection, if required, (e.g., during periods of network interruption) to increase the system's fault tolerance.

In some embodiments, the signal buffer units 452 perform fingerprint extraction and transcoding on the recorded chunks locally. Storage requirements of the resulting fingerprints are trivial compared to the underlying data chunks and can be stored locally along with the data chunks. This enables transmission of the very compact fingerprints including a storyboard over limited-bandwidth networks, to avoid transmitting the full video content.

In some embodiments, the controller 462 manages processing of the data chunks recorded by the signal buffer units 452. The controller 462 constantly monitors the signal buffer units 452 and content analysis nodes 454, performing load balancing as required to maintain efficient usage of system resources. For example, the controller 462 initiates processing of new data chunks by assigning analysis jobs to selected ones of the analysis nodes 454. In some instances, the controller 462 automatically restarts individual analysis processes on the analysis nodes 454, or one or more entire analysis nodes 454, enabling error recovery without user interaction. A graphical user interface, can be provided at the front end 464 for monitor and control of one or more subsystems 442, 444, 446 of the system 400. For example, the graphical user interface allows a user to configure, reconfigure and obtain status of the content analysis 444 subsystem.

In some embodiments, the analysis cluster 444 includes one or more analysis nodes 454 as workhorses of the video detection and monitoring system. Each analysis node 454 independently processes the analysis tasks that are assigned to them by the controller 462. This primarily includes fetching the recorded data chunks, generating the video fingerprints, and matching of the fingerprints against the reference content. The resulting data is stored in the media repository 458 and in the data storage subsystem 446. The analysis nodes 454 can also operate as one or more of reference clips ingestion nodes, backup nodes, or RetroMatch nodes, in case the system performing retrospective matching. Generally, all activity of the analysis cluster is controlled and monitored by the controller.

After processing several such data chunks 470, the detection results for these chunks are stored in the system database 456. Beneficially, the numbers and capacities of signal buffer units 452 and content analysis nodes 454 may flexibly be scaled to customize the system's capacity to specific use cases of any kind. Realizations of the system 400 can include multiple software components that can be combined and configured to suit individual needs. Depending on the specific use case, several components can be run on the same hardware. Alternatively or in addition, components can be run on individual hardware for better performance and improved fault tolerance. Such a modular system architecture allows customization to suit virtually every possible use case. From a local, single-PC solution to nationwide monitoring systems, fault tolerance, recording redundancy, and combinations thereof.

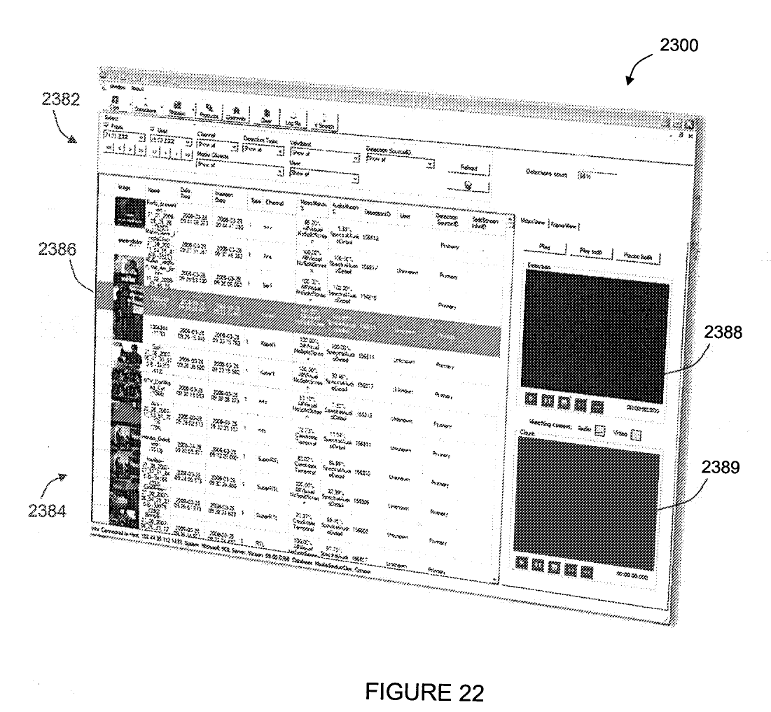

FIG. 22 illustrates a screen shot of an exemplary graphical user interface (GUI) 2300. The GUI 2300 can be utilized by operators, data annalists, and/or other users of the system 100 of FIG. 1 to operate and/or control the content analysis server 110. The GUI 2300 enables users to review detections, manage reference content, edit clip metadata, play reference and detected multimedia content, and perform detailed comparison between reference and detected content. In some embodiments, the system 400 includes or more different graphical user interfaces, for different functions and/or subsystems such as the a recording selector, and a controller front-end 464.

The GUI 2300 includes one or more user-selectable controls 2382, such as standard window control features. The GUI 2300 also includes a detection results table 2384. In the exemplary embodiment, the detection results table 2384 includes multiple rows 2386, one row for each detection. The row 2386 includes a low-resolution version of the stored image together with other information related to the detection itself. Generally, a name or other textual indication of the stored image can be provided next to the image. The detection information can include one or more of: date and time of detection; indicia of the channel or other video source; indication as to the quality of a match; indication as to the quality of an audio match; date of inspection; a detection identification value; and indication as to detection source. In some embodiments, the GUI 2300 also includes a video viewing window 2388 for viewing one or more frames of the detected and matching video. The GUI 2300 can include an audio viewing window 2389 for comparing indicia of an audio comparison.

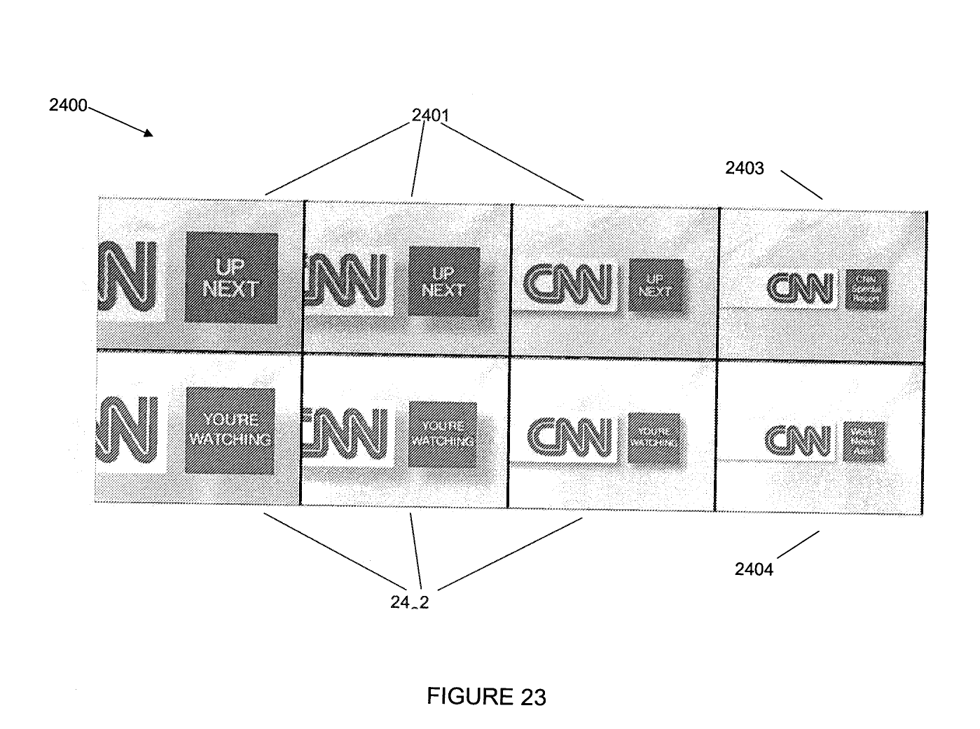

FIG. 23 illustrates an example of a change in a digital image representation subframe. A set of one of: target file image subframes and queried image subframes 900 are shown, wherein the set 2400 includes subframe sets 2401, 2402, 2403, and 2404. Subframe sets 2401 and 2402 differ from other set members in one or more of translation and scale. Subframe sets 2402 and 2403 differ from each other, and differ from subframe sets 2401 and 2402, by image content and present an image difference to a subframe matching threshold.

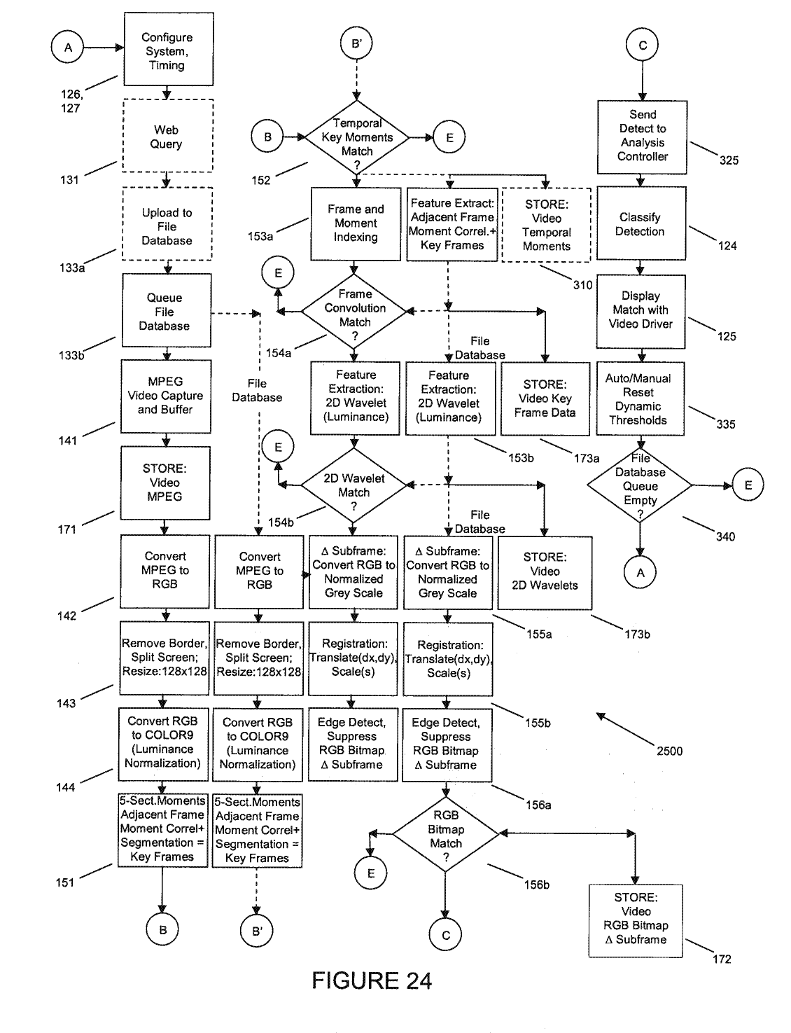

FIG. 24 illustrates an exemplary flow chart 2500 for the digital video image detection system 400 of FIG. 21. The flow chart 2500 initiates at a start point A with a user at a user interface 110 configuring the digital video image detection system 126, wherein configuring the system includes selecting at least one channel, at least one decoding method, and a channel sampling rate, a channel sampling time, and a channel sampling period. Configuring the system 126 includes one of: configuring the digital video image detection system manually and semi-automatically. Configuring the system 126 semi-automatically includes one or more of: selecting channel presets, scanning scheduling codes, and receiving scheduling feeds.

Configuring the digital video image detection system 126 further includes generating a timing control sequence 127, wherein a set of signals generated by the timing control sequence 127 provide for an interface to an MPEG video receiver.

In some embodiments, the method flow chart 2500 for the digital video image detection system 100 provides a step to optionally query the web for a file image 131 for the digital video image detection system 100 to match. In some embodiments, the method flow chart 2500 provides a step to optionally upload from the user interface 100 a file image for the digital video image detection system 100 to match. In some embodiments, querying and queuing a file database 133b provides for at least one file image for the digital video image detection system 100 to match.

The method flow chart 2500 further provides steps for capturing and buffering an MPEG video input at the MPEG video receiver and for storing the MPEG video input 171 as a digital image representation in an MPEG video archive.

The method flow chart 2500 further provides for steps of: converting the MPEG video image to a plurality of query digital image representations, converting the file image to a plurality of file digital image representations, wherein the converting the MPEG video image and the converting the file image are comparable methods, and comparing and matching the queried and file digital image representations. Converting the file image to a plurality of file digital image representations is provided by one of: converting the file image at the time the file image is uploaded, converting the file image at the time the file image is queued, and converting the file image in parallel with converting the MPEG video image.

The method flow chart 2500 provides for a method 142 for converting the MPEG video image and the file image to a queried RGB digital image representation and a file RGB digital image representation, respectively. In some embodiments, converting method 142 further comprises removing an image border 143 from the queried and file RGB digital image representations. In some embodiments, the converting method 142 further comprises removing a split screen 143 from the queried and file RGB digital image representations. In some embodiment, one or more of removing an image border and removing a split screen 143 includes detecting edges. In some embodiments, converting method 142 further comprises resizing the queried and file RGB digital image representations to a size of 128×128 pixels.

The method flow chart 2500 further provides for a method 144 for converting the MPEG video image and the file image to a queried COLOR9 digital image representation and a file COLOR9 digital image representation, respectively. Converting method 144 provides for converting directly from the queried and file RGB digital image representations.

Converting method 144 includes steps of: projecting the queried and file RGB digital image representations onto an intermediate luminance axis, normalizing the queried and file RGB digital image representations with the intermediate luminance, and converting the normalized queried and file RGB digital image representations to a queried and file COLOR9 digital image representation, respectively.

The method flow chart 2500 further provides for a method 151 for converting the MPEG video image and the file image to a queried 5-segment, low resolution temporal moment digital image representation and a file 5-segment, low resolution temporal moment digital image representation, respectively. Converting method 151 provides for converting directly from the queried and file COLOR9 digital image representations.

Converting method 151 includes steps of: sectioning the queried and file COLOR9 digital image representations into five spatial, overlapping sections and non-overlapping sections, generating a set of statistical moments for each of the five sections, weighting the set of statistical moments, and correlating the set of statistical moments temporally, generating a set of key frames or shot frames representative of temporal segments of one or more sequences of COLOR9 digital image representations.

Generating the set of statistical moments for converting method 151 includes generating one or more of: a mean, a variance, and a skew for each of the five sections. In some embodiments, correlating a set of statistical moments temporally for converting method 151 includes correlating one or more of a means, a variance, and a skew of a set of sequentially buffered RGB digital image representations.

Correlating a set of statistical moments temporally for a set of sequentially buffered MPEG video image COLOR9 digital image representations allows for a determination of a set of median statistical moments for one or more segments of consecutive COLOR9 digital image representations. The set of statistical moments of an image frame in the set of temporal segments that most closely matches the a set of median statistical moments is identified as the shot frame, or key frame. The key frame is reserved for further refined methods that yield higher resolution matches.

The method flow chart 2500 further provides for a comparing method 152 for matching the queried and file 5-section, low resolution temporal moment digital image representations. In some embodiments, the first comparing method 151 includes finding an one or more errors between the one or more of a mean, variance, and skew of each of the five segments for the queried and file 5-section, low resolution temporal moment digital image representations. In some embodiments, the one or more errors are generated by one or more queried key frames and one or more file key frames, corresponding to one or more temporal segments of one or more sequences of COLOR9 queried and file digital image representations. In some embodiments, the one or more errors are weighted, wherein the weighting is stronger temporally in a center segment and stronger spatially in a center section than in a set of outer segments and sections.

Comparing method 152 includes a branching element ending the method flow chart 2500 at ‘E’ if the first comparing results in no match. Comparing method 152 includes a branching element directing the method flow chart 2500 to a converting method 153 if the comparing method 152 results in a match.

In some embodiments, a match in the comparing method 152 includes one or more of a distance between queried and file means, a distance between queried and file variances, and a distance between queried and file skews registering a smaller metric than a mean threshold, a variance threshold, and a skew threshold, respectively. The metric for the first comparing method 152 can be any of a set of well known distance generating metrics.

A converting method 153a includes a method of extracting a set of high resolution temporal moments from the queried and file COLOR9 digital image representations, wherein the set of high resolution temporal moments include one or more of: a mean, a variance, and a skew for each of a set of images in an image segment representative of temporal segments of one or more sequences of COLOR9 digital image representations.

Converting method 153a temporal moments are provided by converting method 151. Converting method 153a indexes the set of images and corresponding set of statistical moments to a time sequence. Comparing method 154a compares the statistical moments for the queried and the file image sets for each temporal segment by convolution.

The convolution in comparing method 154a convolves the queried and filed one or more of: the first feature mean, the first feature variance, and the first feature skew. In some embodiments, the convolution is weighted, wherein the weighting is a function of chrominance. In some embodiments, the convolution is weighted, wherein the weighting is a function of hue.

The comparing method 154a includes a branching element ending the method flow chart 2500 if the first feature comparing results in no match. Comparing method 154a includes a branching element directing the method flow chart 2500 to a converting method 153b if the first feature comparing method 153a results in a match.

In some embodiments, a match in the first feature comparing method 153a includes one or more of: a distance between queried and file first feature means, a distance between queried and file first feature variances, and a distance between queried and file first feature skews registering a smaller metric than a first feature mean threshold, a first feature variance threshold, and a first feature skew threshold, respectively. The metric for the first feature comparing method 153a can be any of a set of well known distance generating metrics.

The converting method 153b includes extracting a set of nine queried and file wavelet transform coefficients from the queried and file COLOR9 digital image representations. Specifically, the set of nine queried and file wavelet transform coefficients are generated from a grey scale representation of each of the nine color representations comprising the COLOR9 digital image representation. In some embodiments, the grey scale representation is approximately equivalent to a corresponding luminance representation of each of the nine color representations comprising the COLOR9 digital image representation. In some embodiments, the grey scale representation is generated by a process commonly referred to as color gamut sphering, wherein color gamut sphering approximately eliminates or normalizes brightness and saturation across the nine color representations comprising the COLOR9 digital image representation.

In some embodiments, the set of nine wavelet transform coefficients are one of: a set of nine one-dimensional wavelet transform coefficients, a set of one or more non-collinear sets of nine one-dimensional wavelet transform coefficients, and a set of nine two-dimensional wavelet transform coefficients. In some embodiments, the set of nine wavelet transform coefficients are one of: a set of Haar wavelet transform coefficients and a two-dimensional set of Haar wavelet transform coefficients.

The method flow chart 2500 further provides for a comparing method 154b for matching the set of nine queried and file wavelet transform coefficients. In some embodiments, the comparing method 154b includes a correlation function for the set of nine queried and filed wavelet transform coefficients. In some embodiments, the correlation function is weighted, wherein the weighting is a function of hue; that is, the weighting is a function of each of the nine color representations comprising the COLOR9 digital image representation.

The comparing method 154b includes a branching element ending the method flow chart 2500 if the comparing method 154b results in no match. The comparing method 154b includes a branching element directing the method flow chart 2500 to an analysis method 155a-156b if the comparing method 154b results in a match.

In some embodiments, the comparing in comparing method 154b includes one or more of: a distance between the set of nine queried and file wavelet coefficients, a distance between a selected set of nine queried and file wavelet coefficients, and a distance between a weighted set of nine queried and file wavelet coefficients.

The analysis method 155a-156b provides for converting the MPEG video image and the file image to one or more queried RGB digital image representation subframes and file RGB digital image representation subframes, respectively, one or more grey scale digital image representation subframes and file grey scale digital image representation subframes, respectively, and one or more RGB digital image representation difference subframes. The analysis method 155a-156b provides for converting directly from the queried and file RGB digital image representations to the associated subframes.

The analysis method 55a-156b provides for the one or more queried and file grey scale digital image representation subframes 155a, including: defining one or more portions of the queried and file RGB digital image representations as one or more queried and file RGB digital image representation subframes, converting the one or more queried and file RGB digital image representation subframes to one or more queried and file grey scale digital image representation subframes, and normalizing the one or more queried and file grey scale digital image representation subframes.

The method for defining includes initially defining identical pixels for each pair of the one or more queried and file RGB digital image representations. The method for converting includes extracting a luminance measure from each pair of the queried and file RGB digital image representation subframes to facilitate the converting. The method of normalizing includes subtracting a mean from each pair of the one or more queried and file grey scale digital image representation subframes.

The analysis method 155a-156b further provides for a comparing method 155b-156b. The comparing method 155b-156b includes a branching element ending the method flow chart 2500 if the second comparing results in no match. The comparing method 155b-156b includes a branching element directing the method flow chart 2500 to a detection analysis method 325 if the second comparing method 155b-156b results in a match.

The comparing method 155b-156b includes: providing a registration between each pair of the one or more queried and file grey scale digital image representation subframes 155b and rendering one or more RGB digital image representation difference subframes and a connected queried RGB digital image representation dilated change subframe 156a-b.

The method for providing a registration between each pair of the one or more queried and file grey scale digital image representation subframes 155b includes: providing a sum of absolute differences (SAD) metric by summing the absolute value of a grey scale pixel difference between each pair of the one or more queried and file grey scale digital image representation subframes, translating and scaling the one or more queried grey scale digital image representation subframes, and repeating to find a minimum SAD for each pair of the one or more queried and file grey scale digital image representation subframes. The scaling for method 155b includes independently scaling the one or more queried grey scale digital image representation subframes to one of: a 128×128 pixel subframe, a 64×64 pixel subframe, and a 32×32 pixel subframe.

The scaling for method 155b includes independently scaling the one or more queried grey scale digital image representation subframes to one of: a 720×480 pixel (480i/p) subframe, a 720×576 pixel (576 i/p) subframe, a 1280×720 pixel (720p) subframe, a 1280×1080 pixel (1080i) subframe, and a 1920×1080 pixel (1080p) subframe, wherein scaling can be made from the RGB representation image or directly from the MPEG image.

The method for rendering one or more RGB digital image representation difference subframes and a connected queried RGB digital image representation dilated change subframe 156a-b includes: aligning the one or more queried and file grey scale digital image representation subframes in accordance with the method for providing a registration 155b, providing one or more RGB digital image representation difference subframes, and providing a connected queried RGB digital image representation dilated change subframe.

The providing the one or more RGB digital image representation difference subframes in method 56a includes: suppressing the edges in the one or more queried and file RGB digital image representation subframes, providing a SAD metric by summing the absolute value of the RGB pixel difference between each pair of the one or more queried and file RGB digital image representation subframes, and defining the one or more RGB digital image representation difference subframes as a set wherein the corresponding SAD is below a threshold.

The suppressing includes: providing an edge map for the one or more queried and file RGB digital image representation subframes and subtracting the edge map for the one or more queried and file RGB digital image representation subframes from the one or more queried and file RGB digital image representation subframes, wherein providing an edge map includes providing a Sobol filter.

The providing the connected queried RGB digital image representation dilated change subframe in method 56a includes: connecting and dilating a set of one or more queried RGB digital image representation subframes that correspond to the set of one or more RGB digital image representation difference subframes.

The method for rendering one or more RGB digital image representation difference subframes and a connected queried RGB digital image representation dilated change subframe 156a-b includes a scaling for method 156a-b independently scaling the one or more queried RGB digital image representation subframes to one of: a 128×128 pixel subframe, a 64×64 pixel subframe, and a 32×32 pixel subframe.

The scaling for method 156a-b includes independently scaling the one or more queried RGB digital image representation subframes to one of: a 720×480 pixel (480i/p) subframe, a 720×576 pixel (576 i/p) subframe, a 1280×720 pixel (720p) subframe, a 1280×1080 pixel (1080i) subframe, and a 1920×1080 pixel (1080p) subframe, wherein scaling can be made from the RGB representation image or directly from the MPEG image.

The method flow chart 2500 further provides for a detection analysis method 325. The detection analysis method 325 and the associated classify detection method 124 provide video detection match and classification data and images for the display match and video driver 125, as controlled by the user interface 110. The detection analysis method 325 and the classify detection method 124 further provide detection data to a dynamic thresholds method 335, wherein the dynamic thresholds method 335 provides for one of: automatic reset of dynamic thresholds, manual reset of dynamic thresholds, and combinations thereof.

The method flow chart 2500 further provides a third comparing method 340, providing a branching element ending the method flow chart 2500 if the file database queue is not empty.

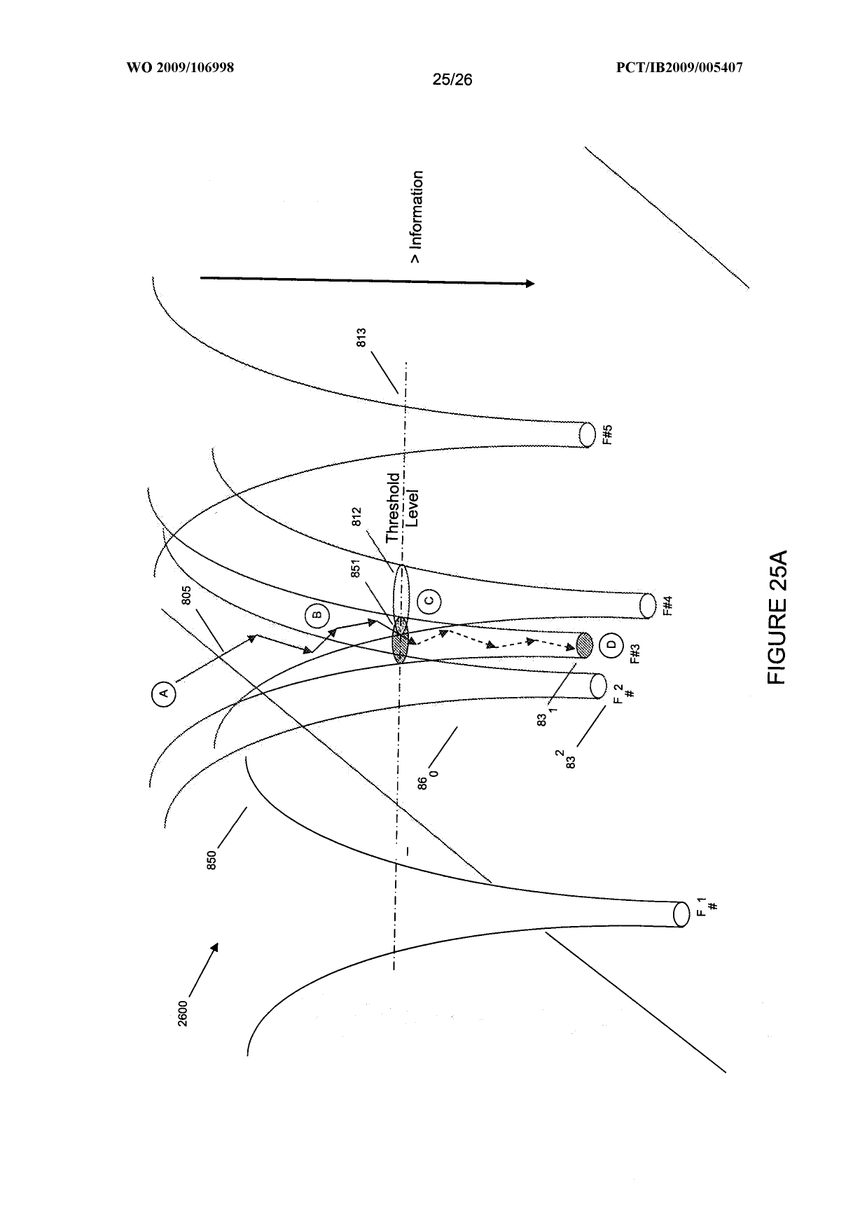

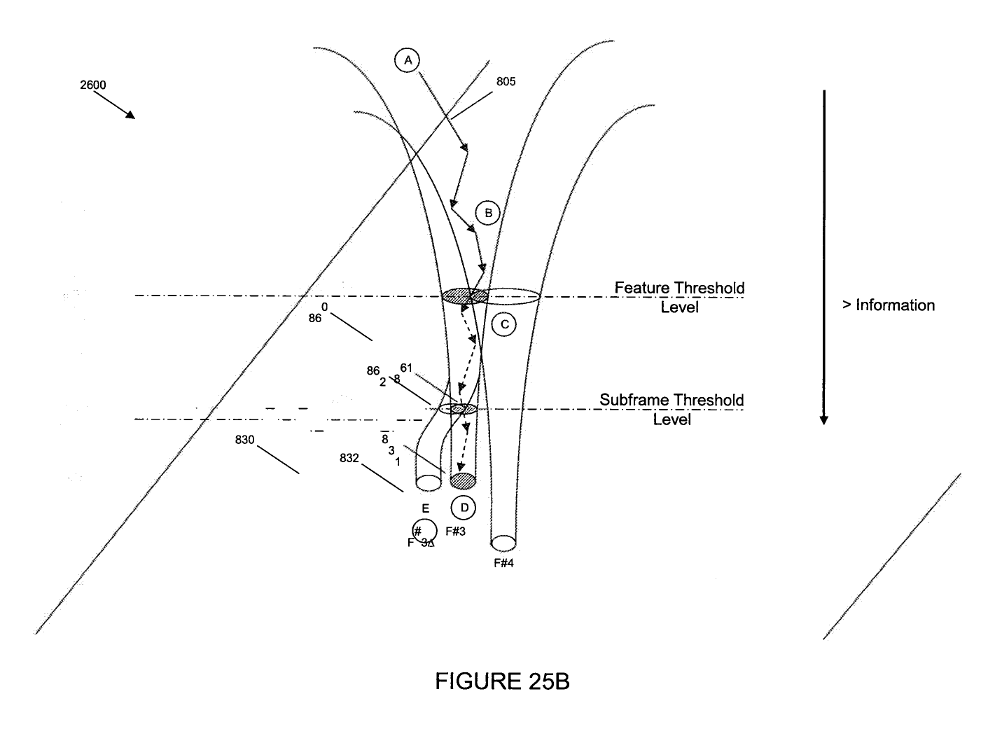

FIG. 25A illustrates an exemplary traversed set of K-NN nested, disjoint feature subspaces in feature space 2600. A queried image 805 starts at A and is funneled to a target file image 831 at D, winnowing file images that fail matching criteria 851 and 852, such as file image 832 at threshold level 813, at a boundary between feature spaces 850 and 860.

FIG. 25B illustrates the exemplary traversed set of K-NN nested, disjoint feature subspaces with a change in a queried image subframe. The a queried image 805 subframe 861 and a target file image 831 subframe 862 do not match at a subframe threshold at a boundary between feature spaces 860 and 830. A match is found with file image 832, and a new subframe 832 is generated and associated with both file image 831 and the queried image 805, wherein both target file image 831 subframe 961 and new subframe 832 comprise a new subspace set for file target image 832.

In some examples, the content analysis server 110 of FIG. 1 is a Web portal. The Web portal implementation allows for flexible, on demand monitoring offered as a service. With need for little more than web access, a web portal implementation allows clients with small reference data volumes to benefit from the advantages of the video detection systems and processes of the present invention. Solutions can offer one or more of several programming interfaces using Microsoft .Net Remoting for seamless in-house integration with existing applications. Alternatively or in addition, long-term storage for recorded video data and operative redundancy can be added by installing a secondary controller and secondary signal buffer units.

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The communication network can include, for example, a packet-based network and/or a circuit-based network. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The communication device can include, for example, a computer, a computer with a browser device, a telephone, an IP phone, a mobile device (e.g., cellular phone, personal digital assistant (PDA) device, laptop computer, electronic mail device), and/or other type of communication device. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a personal digital assistant (PDA).

Comprise, include, and/or plural forms of each are open ended and include the listed parts and can include additional parts that are not listed. And/or is open ended and includes one or more of the listed parts and combinations of the listed parts.

In general, the term video refers to a sequence of still images, or frames, representing scenes in motion. Thus, the video frame itself is a still picture. The terms video and multimedia as used herein include television and film-style video clips and streaming media. Video and multimedia include analog formats, such as standard television broadcasting and recording and digital formats, also including standard television broadcasting and recording (e.g., DTV). Video can be interlaced or progressive. The video and multimedia content described herein may be processed according to various storage formats, including: digital video formats (e.g., DVD), QuickTime®, and MPEG 4; and analog videotapes, including VHS® and Betamax®. Formats for digital television broadcasts may use the MPEG-2 video codec and include: ATSC—USA, Canada DVB—Europe ISDB—Japan, Brazil DMB—Korea. Analog television broadcast standards include: FCS—USA, Russia; obsolete MAC—Europe; obsolete MUSE—Japan NTSC—USA, Canada, Japan PAL—Europe, Asia, Oceania PAL-M—PAL variation. Brazil PALplus—PAL extension, Europe RS-343 (military) SECAM—France, Former Soviet Union, Central Africa. Video and multimedia as used herein also include video on demand referring to videos that start at a moment of the user's choice, as opposed to streaming, multicast.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method of comparing video sequences, comprising:
receiving a first list of descriptors pertaining to a plurality of first video frames, each of the descriptors relating to visual information of a corresponding video frame of the plurality of first video frames;
receiving a second list of descriptors pertaining to a plurality of second video frames, each of the descriptors relating to visual information of a corresponding video frame of the plurality of second video frames;
designating first segments of the plurality of first video frames that are similar, each first segment comprising neighboring first video frames;
designating second segments of the plurality of second video frames that are similar, each second segment comprising neighboring second video frames;
comparing the first segments and the second segments; and
analyzing the pairs of first and second segments based on the comparison of the first segments and the second segments to compare the first and second segments to a threshold value.

2. The method of claim 1, wherein the act of analyzing comprises determining similar first and second segments.

3. The method of claim 1, wherein the act of analyzing comprises determining dissimilar first and second segments.

4. The method of claims 2 through 3, wherein the act of determining comprises:
calculating a difference between respective descriptors of the first and second segments; and
comparing the calculated difference to a threshold value.

5. The method of claim 1, wherein the act of comparing comprises comparing each first segment to each second segment.

6. The method of claim 1, wherein the act of comparing comprises comparing each first segment to each second segment that is located within an adaptive window.

7. The method of claim 6, wherein the act of comparing comprises
calculating a difference between respective descriptors of each first and second segment being compared; and
comparing the calculated difference to a threshold value.

8. The method of claim 7, further comprising varying a size of the adaptive window during the comparing.

9. The method of claim 1, wherein the act of comparing comprises:
designating first clusters of first segments formed of a plurality of first segments;
for each first cluster, selecting a first segment of the plurality of first segments of that cluster to be a first cluster centroid;
comparing each of the first cluster centroids to each of the second segments; and
for each of the second segments within a threshold value of each of the first cluster centroids, comparing the second segments and the first segments of the first cluster.

10. The method of claim 9, wherein the act of comparing comprises:
calculating a difference between respective descriptors of the cluster centroids of each of the first and second segments being compared; and
comparing the calculated difference to a threshold value.

11. The method of claim 1, wherein the act of comparing comprises:
designating first clusters of first segments formed of a plurality of first segments;
for each first cluster, selecting a first segment of the plurality of first segments of that cluster to be a first cluster centroid;
designating second clusters of second segments formed of a plurality of second segments;
for each second cluster, selecting a second segment of the plurality of second segments of that cluster to be a second cluster centroid;
comparing each of the first cluster centroids to each of the second cluster centroids; and
for each of the first cluster centroids within a threshold value of each of the second cluster centroids, comparing the first segments of the first cluster and the second segments of the second cluster to each other.

12. The method of claim 11, wherein the act of comparing each of the first cluster centroids to each of the second cluster centroids comprises:
calculating a difference between respective descriptors of the cluster centroids of each of the first and second segments being compared; and
comparing the calculated difference to a threshold value.

13. The method of claim 1, further comprising generating the threshold value based on the descriptors relating to visual information of a first video frame of the plurality of first video frames, the descriptors relating to visual information of a second video frame of the plurality of second video frames, and/or any combination thereof.

14. The method of claim 1, wherein the act of analyzing is performed using at least one matrix and searching for diagonals of entries in the at least one matrix representing levels of differences in segments of similar video frames.

15. The method of claim 1, further comprising finding similar frame sequences for previously unmatched frame sequences.

16. A computer program product, tangibly embodied in an information carrier, the computer program product including instructions being operable to cause a data processing apparatus to:
receive a first list of descriptors pertaining to a plurality of first video frames, each of the descriptors relating to visual information of a corresponding video frame of the plurality of first video frames;
receive a second list of descriptors pertaining to a plurality of second video frames, each of the descriptors relating to visual information of a corresponding video frame of the plurality of second video frames;
designate first segments of the plurality of first video frames that are similar, each first segment comprising neighboring first video frames;
designate second segments of the plurality of second video frames that are similar, each second segment comprising neighboring second video frames;
compare the first segments and the second segments; and
analyze the pairs of first and second segments based on the comparison of the first segments and the second segments to compare the first and second segments to a threshold value.

17. A system of comparing video sequences, comprising:
a communication module to:
receive a first list of descriptors pertaining to a plurality of first video frames, each of the descriptors relating to visual information of a corresponding video frame of the plurality of first video frames;
receive a second list of descriptors pertaining to a plurality of second video frames, each of the descriptors relating to visual information of a corresponding video frame of the plurality of second video frames;
a video segmentation module to:
designate first segments of the plurality of first video frames that are similar, each first segment comprising neighboring first video frames;
designate second segments of the plurality of second video frames that are similar, each second segment comprising neighboring second video frames;
a video segment comparison module to:
compare the first segments and the second segments; and
analyze the pairs of first and second segments based on the comparison of the first segments and the second segments to compare the first and second segments to a threshold value.

18. A system of comparing video sequences, comprising:
means for receiving a first list of descriptors pertaining to a plurality of first video frames, each of the descriptors relating to visual information of a corresponding video frame of the plurality of first video frames;
means for receiving a second list of descriptors pertaining to a plurality of second video frames, each of the descriptors relating to visual information of a corresponding video frame of the plurality of second video frames;
means for designating first segments of the plurality of first video frames that are similar, each first segment comprising neighboring first video frames;
means for designating second segments of the plurality of second video frames that are similar, each second segment comprising neighboring second video frames;
means for comparing the first segments and the second segments; and
means for analyzing the pairs of first and second segments based on the comparison of the first segments and the second segments to compare the first and second segments to a threshold value.
